(19) United States
(12) Patent Application Publication
(10) Pub. No.: US 2026/0292262 A1
(43) Pub. Date: Sep. 24, 2026

(54) POSITION DEPENDENT FILTERING

(71) Applicant: Telefonaktiebolaget LM Ericsson (publ), Stockholm (SE)

(72) Inventors: Jacob STRÖM, Stockholm (SE); Per WENNERSTEN, Årsta (SE); Rickard SJÖBERG, Stockholm (SE); Du LIU, Solna (SE); Mitra DAMGHANIAN, Upplands-Bro (SE); Kenneth ANDERSSON, Gävle (SE)

(73) Assignee: Telefonaktiebolaget LM Ericsson (publ), Stockholm (SE)

(21) Appl. No.: 19/473,702

(22) PCT Filed: Mar. 28, 2024
(86) PCT No.: PCT/SE2024/050287

§ 371 Date: Oct. 8, 2025

Related U.S. Application Data
(60) Provisional application No. 63/458,823, filed on Apr. 12, 2023.

(51) Int. Cl. H04N 19/82; G06N 3/045; G06N 3/048; H04N 19/136; H04N 19/167

(52) U.S. Cl. CPC H04N 19/82; G06N 3/045; G06N 3/048; H04N 19/136; H04N 19/167

(57) ABSTRACT

A method, comprising identifying a first group within a set of inputs, wherein the first group comprises a first plurality of values. The method comprises selecting a first weight tensor, wherein the first weight tensor is selected based at least in pant on a position of a first value. The method comprises generating a first weighted sum by applying the first weight tensor to the first plurality of values. The method comprises identifying a second group within the set of inputs, wherein the second group comprises a second plurality of values. The method comprises selecting a second weight tensor, wherein the second weight tensor is selected based at least in part on a position of a second value, wherein the second weight tensor is different than the first weight tensor. The method comprises generating a second weighted sum by applying the second weight tensor to the second plurality of values. The method comprises identifying a third group within a set of inputs, wherein the third group comprises a third plurality of values. The method comprises selecting a third weight tensor, wherein the third weight tensor is selected based at least in part on a position of a third value. The method comprises generating a third weighted sum by applying the third weight tensor to the third plurality of values, wherein the first and third weight tensors are the same. The method further comprises performing one or more of: generating a first output value by processing the first weighted sum with a non-linear activation function, generating a second output value by processing the second weighted sum with a non-linear activation function and generating a third output value by processing the third weighted sum with a non-linear activation function.

### TECHNICAL FIELD

This disclosure relates to methods and apparatus for performing filtering, and in particular, filtering for video encoding and decoding. Aspects of this disclosure address, for example, video compression, video coding, image compression, image coding, neural network-based video coding, neural network-based loop filtering, loop filtering, and postfiltering. However, embodiments may also be applicable to non-video technologies, including audio and text.

### INTRODUCTION

Video is the dominant form of data traffic in today's networks and is projected to continuously increase its share. One way to reduce the data traffic from video is compression. In the compression, the source video is encoded into a bitstream, which then can be stored and transmitted to end users. Using a decoder, the end user can extract the video data and display it on a screen.

However, since the encoder does not know what kind of device the encoded bitstream is going to be sent to, the encoder must compress the video into a standardized format. Then all devices that support the chosen standard can successfully decode the video. Compression can be lossless, i.e., the decoded video will be identical to the source video that was given to the encoder, or lossy, where a certain degradation of content is accepted. Using lossy compression can allow for significantly lower bit rates, i.e., the compression ratio can be much higher. This is because reproducing image noise perfectly can make lossless compression quite expensive.

A video sequence contains a sequence of pictures. A color space commonly used in video sequences is YCbCr, where Y is the luma (brightness) component, and Cb and Cr are the chroma components. Sometimes the Cb and Cr components are called U and V. Other color spaces are also used, such as ICtCp (a.k.a., IPT) (where I is the luma component, and Ct and Cp are the chroma components), constant-luminance YCbCr (where Y is the luma components, and Cb and Cr are the chroma components), RGB (where R, G, and B correspond to blue, green, and blue components respectively), YCoCg (where Y is the luma components, and Co and Cg are the chroma components), etc.

The order that the pictures are placed in the video sequence is called “display order.” Each picture is assigned with a Picture Order Count (POC) value to indicate its display order. In this disclosure, the terms “images,” “pictures” or “frames” are used interchangeably.

Video compression is used to compress video sequences into a sequence of coded pictures. In many existing video codecs, the picture is divided into blocks of different sizes. A block is a two-dimensional array of samples. The blocks serve as the basis for coding. A video decoder then decodes the coded pictures into pictures containing sample values.

Video standards are usually developed by international organizations as these represent different companies and research institutes with different areas of expertise and interests. The currently most applied video compression standard is H.264/AVC (Advanced Video Coding) which was jointly developed by ITU-T and ISO. The first version of H.264/AVC was finalized in 2003, with several updates in the following years. The successor of H.264/AVC, which was also developed by ITU-T (International Telecommunication Union-Telecommunication) and International Organization for Standardization (ISO), is known as H.265/HEVC (High Efficiency Video Coding) and was finalized in 2013. MPEG and ITU-T have created a successor to HEVC within the Joint Video Exploratory Team (JVET). The name of this video codec is Versatile Video Coding (VVC) and version 1 of the VVC specification has been published as Rec. ITU-T H.266 | ISO/IEC (International Electrotechnical Commission) 23090-3, “Versatile Video Coding”, 2020.

The VVC video coding standard is a block-based video codec and utilizes both temporal and spatial prediction. Spatial prediction is achieved using intra (I) prediction from within the current picture. Temporal prediction is achieved using uni-directional (P) or bi-directional inter (B) prediction at the block level from previously decoded reference pictures. In the encoder, the difference between the original sample data and the predicted sample data, referred to as the residual, is transformed into the frequency domain, quantized, and then entropy coded before being transmitted together with necessary prediction parameters such as prediction mode and motion vectors (which may also be entropy coded). The decoder performs entropy decoding, inverse quantization, and inverse transformation to obtain the residual, and then adds the residual to the intra or inter prediction to reconstruct a picture.

The VVC video coding standard uses a block structure referred to as quadtree plus binary tree plus ternary tree block structure (QTBT+TT), where each picture is first partitioned into square blocks called coding tree units (CTU). All CTUs are of the same size and the partitioning of the picture into CTUs is done without any syntax controlling it. Each CTU is further partitioned into coding units (CUs) that can have either square or rectangular shapes. The CTU is first partitioned by a quad tree structure, then it may be further partitioned with equally sized partitions either vertically or horizontally in a binary structure to form coding units (CUs). A block could thus have either a square or rectangular shape. The depth of the quad tree and binary tree can be set by the encoder in the bitstream. The ternary tree (TT) part adds the possibility to divide a CU into three partitions instead of two equally sized partitions. This increases the possibilities to use a block structure that better fits the content structure of a picture, such as roughly following important edges in the picture.

A block that is intra coded is an I-block. A block that is uni-directional predicted is a P-block and a block that is bi-directional predicted a B-block. For some blocks, the encoder decides that encoding the residual is not necessary, perhaps because the prediction is sufficiently close to the original. The encoder then signals to the decoder that the transform coding of that block should be bypassed, i.e., skipped. Such a block is referred to as a skip-block.

At the 20th JVET meeting it was decided to set up an exploration experiment (EE) on neural network-based (NN-based) video coding. The exploration experiment continued at the subsequent JVET meetings 21 through 29 with additional tests, including NN-based in-loop filtering, NN-based post filtering, NN-based super resolution, and NN-based intra prediction.

With respect to in-loop filtering, VVC contains three in-loop filters that are presently not based on neural networks: a deblocking filter, a sample adaptive offset (SAO) filter, and an adaptive loop filter (ALF). The deblocking filter is used to remove block artifacts by smoothing discontinuities in horizontal and vertical directions across block boundaries. The deblocking filter uses a block boundary strength (BS) parameter to determine the filtering strength. The BS can have values 0, 1, and 2, where a larger value indicates a stronger filtering. The output of the deblocking filter is further processed by SAO, and the output of SAO is then processed by ALF. The output of the ALF filter can then be put into the display picture buffer (DPB), which is used for prediction of subsequently encoded (or decoded) pictures. Since the deblocking filter, SAO filter and ALF filter can influence the pictures in the DPB used for prediction, they are classified as in-loop filters, also known as loopfilters. This means that changes done by the loopfilter may influence not only the current picture but future pictures as well. It is possible for a decoder to further filter the picture in the DPB, but not store the filtered output in the DPB, but only send it to the display/decoded file. In contrast to loopfilters, such a filter is not influencing future predictions and is therefore classified as a post-processing filter, also known as a postfilter.

The contributions JVET-X0066 and JVET-Y0143 are two successive contributions that describe NN-based in-loop filtering. Both contributions use the same NN models for filtering. The NN-based in-loop filter is placed before SAO and ALF and the samples before the deblocking filter are used as input to the filter. One purpose of using the NN-based filter is to improve the quality of the reconstructed samples. Here it is helpful that the NN model is non-linear. While deblocking, SAO, and ALF all contain non-linear elements such as conditions, and are thus not strictly linear, all three of them are based on linear filters. In contrast, a sufficiently large NN model can—in principle—learn any non-linear mapping, and is therefore capable of representing a wider class of functions compared to deblocking, SAO, and ALF. In JVET-X0066 and JVET-Y0143, there are four NN models (i.e., four NN-based in-loop filters). In a refined version of that work presented in the contribution JVET-AB0052, only two models are used: one for luma samples and another model for chroma samples. The use of NN filtering can be controlled (turned on or off) on a block (CTU) level or a picture level. The encoder can further determine the strength of the filtering for the blocks/pictures where it is turned on.

The two NN models are convolutional neural networks. The terms “neural network”, “neural network model”, and “NN model” can be used interchangeably. Using the model for luma samples as an example, the model from JVET-AB0052 has five inputs, the reconstructed samples of luma before deblocking (called ‘rec’), the prediction samples of luma (‘pred’), the BS information of luma (bs), the quantization parameter (qp) as well as information on whether a particular sample was intra-predicted, uni-predicted or bi-predicted (called ‘IPB’). These five inputs first go through a convolutional layer and a parametric rectified linear unit (PReLU) layer separately, then they are concatenated and fused together to generate the signal y, as shown in FIG. 4A. This figure shows the “head” of the neural network, which includes the input, a fusion part, and a transition part.

Each input is connected to a convolutional layer with a kernel size of 3×3, denoted “conv3×3” in the figure, with a multitude of output channels. As an example, in JVET-AB0052, 96 channels are used for each input, whereas in JVET-AC0126, more channels are used for the ‘rec’ input and fewer are used for the ‘QP’ input, since the ‘rec’ input typically carries more information about the signal than does the ‘QP’ input. The fuse part contains a “conv1×1” layer which is a convolutional layer with kernel size 1×1. In both JVET-AB0052 and JVET-AC0126, this layer has 5*96=480 input channels and 96 output channels. The PReLUs make up the activation layer. “Unsqueeze, expand” is the dimension manipulation that expands qp, which in the experimental software NNVC is just a single number, into the same size as other inputs such as a 128×128- or 256×256-sample array. It should be noted that in many applications it may be the case that different samples inside the CTU will be associated with different qps. In this case the qp would effectively be of the same resolution as the other inputs (rec, pred, part and bs) and the “unsqueeze, expand”-layer would not be needed. Finally, “concat” means concatenation and “2↓” denotes downsampling with a factor of 2.

After the head, there are N sequential residual blocks of the same structure. In JVET-AB0052 and JVET-AC0126, N=8. The first residual block inputs y and outputs z0. The i-th residual block outputs zᵢ, i=0, . . . , 7. The structure of the residual block is depicted in FIG. 4B. After eight residual blocks, the signal z7 is processed by a convolutional layer, a PReLU, another convolutional layer, pixel shuffling, and a final scaling to generate the output, as shown in FIG. 4C. The chroma models are different from the luma models. For instance, the chroma models take the reconstructed luma samples (‘rec’) as input. However, embodiments of the disclosure are applicable to both luma and chroma processing.

There remains a need for improved filtering. For example, the NN-based in-loop filters presented in JVET-X0066, JVET-AB0053, JVET-AB0052, and JVET-AC0126 increase the compression efficiency of the codec substantially (i.e., they lower the bit rate substantially without lowering the objective quality as measured by MSE-based PSNR). Increases in compression efficiency, often referred to simply as “gain”, are often measured as the Bjontegaard-delta rate (BDR) against an anchor. As an example, a BDR of −1% means that the same PSNR distortion can be reached with 1% fewer bits. As reported in JVET-Y0143, for the random access (RA) configuration, the BDR gain for the luma component (Y) is −9.80%, and for the all-intra (AI) configuration, the BDR gain for the luma component is −7.39%. The complexity of NN models used for compression are often measured by MAC/pixel (multiply-accumulate operations per pixel). The high gain of NN model is directly related to the high complexity of the NN model. The luma intra model described in JVET-Y0143 has a complexity of 430 kMAC/pixel (i.e., 430,000 multiply-accumulate operations per pixel). There are also other measures of complexity, such as total model size in terms of stored parameters. As another example, in some frameworks, such as in Keras, it is possible to have a convolutional layer where the weights are different in every output position. In Keras such a layer is called LocallyConnected2D. This means that the number of parameters increases extremely quickly with the size of the input, making only very small input image sizes feasible.

### SUMMARY

Methods for improving the complexity-performance tradeoff are highly valued in NN-based video coding. The structure of the existing NN model can be improved. For instance, it is possible to keep the compression efficiency performance the same (or even improve it) while lowering the complexity. The high complexity of current NN models is a significant challenge for practical hardware implementations. Reducing the complexity while preserving the NN compression efficiency performance is therefore highly desirable. As an example, a lower number of kMACs/sample means that less power is consumed in a wireless device, increasing battery life. It also means that a smaller surface area of a chip needs to be devoted to video decoding, lowering manufacturing cost. A lowered bit rate at constant complexity can often be traded for a lowered complexity at a constant bit rate and vice versa. Therefore, increasing coding efficiency while keeping the complexity the same is also highly desirable.

Current state-of-the-art NN-based loopfilters are built on convolutional neural networks. These networks have the property that the same weights are used for all convolution positions. However, the output signal (‘rec’) from a video codec is not translation invariant. As an example, the smallest transform is 4×4 samples large, and the top left sample of a block undergoing such a transform must thus have x- and y-coordinates divisible by four. A consequence of this is that samples near the edges of a 4×4 block are more likely to be affected by block artifacts compared to samples in the center of the block. Therefore, according to embodiments, methods and devices are provided to better adapt to this position-dependent nature of the signal by allowing position dependent weights in the network, in an efficient manner. Another aspect of embodiments is to make the network aware of the position within the image, so that it can treat different positions differently. In certain aspects, the network can have the potential to exploit the known and existing signal properties to improve performance.

According to a first aspect of the present disclosure, there is provided a method. The method comprises identifying a first group within a set of inputs, wherein the first group comprises a first plurality of values. The method comprises selecting a first weight tensor, wherein the first weight tensor is selected based at least in part on a position of a first value. The method comprises generating a first weighted sum by applying the first weight tensor to the first plurality of values. The method comprises identifying a second group within the set of inputs, wherein the second group comprises a second plurality of values. The method comprises selecting a second weight tensor, wherein the second weight tensor is selected based at least in part on a position of a second value, wherein the second weight tensor is different than the first weight tensor. The method comprises generating a second weighted sum by applying the second weight tensor to the second plurality of values. The method comprises identifying a third group within a set of inputs, wherein the third group comprises a third plurality of values. The method comprises selecting a third weight tensor, wherein the third weight tensor is selected based at least in part on a position of a third value. The method comprises generating a third weighted sum by applying the third weight tensor to the third plurality of values, wherein the first and third weight tensors are the same. The method further comprises performing one or more of: generating a first output value by processing the first weighted sum with a non-linear activation function, generating a second output value by processing the second weighted sum with a non-linear activation function and generating a third output value by processing the third weighted sum with a non-linear activation function.

According to a second aspect of the present disclosure, there is provided an apparatus configured to perform the method according to the first aspect.

According to a third aspect of the present disclosure, there is provided a computer program comprising instructions that when executed by processing circuitry cause the processing circuitry to perform the method according to the first aspect.

According to a fourth aspect of the present disclosure, there is provided a carrier containing the computer program according to the third aspect, wherein the carrier is one of an electronic signal, an optical signal, a radio signal, and a computer readable storage medium.

Certain embodiments may provide one or more of the following technical advantage(s). For example, one advantage of the proposed solution(s) is an improved performance vs. complexity trade-off in the codec. The BD-rate can be lowered by more than half a percentage point without increasing the complexity in terms of kMACs/sample. This means that, according to some embodiments, the bit rate is 0.5% lower, even though picture quality in terms of PSNR does not change, while the complexity in terms of kMACs/sample is not increased. Another aspect is that the proposed solution(s) need only up to a quarter of the computations and a quarter of the number of parameters compared to other technologies.

### BRIEF DESCRIPTION OF THE DRAWINGS

The accompanying drawings, which are incorporated herein and form part of the specification, illustrate various embodiments.

FIGS. 1A, 1B, and 1C each show a system according to some embodiments.

FIG. 2 shows a schematic block diagram of an encoder according to some embodiments.

FIG. 3 shows a schematic block diagram of a decoder according to some embodiments.

FIG. 4A shows a schematic block diagram of an example of a head using five inputs. FIG. 4B shows a schematic block diagram of an example body with repeated residual blocks. FIG. 4C shows a schematic block diagram of an example tail having final processing that includes pixel shuffling.

FIGS. 5A and 5B illustrate aspects of filtering.

FIG. 6 illustrates the division of a picture into blocks according to embodiments.

FIGS. 7, 8, 9A, and 9B illustrate the use of weight tensors according to embodiments.

FIGS. 10 and 11 are performance graphs showing simulation results.

FIGS. 12, 13, 14A, and 14B illustrate the use of weight tensors according to embodiments.

FIGS. 15 and 16 illustrate examples of shared weight matrices inside a repeater matrix according to embodiments.

FIGS. 17 and 18 illustrate the use of weight tensors according to embodiments.

FIGS. 19-25 illustrate the use of pixel shuffle and unshuffled operations according to embodiments.

FIGS. 26 and 27 illustrate repeater matrix pattern according to some embodiments.

FIGS. 28-30 illustrate the use of inputs for matrix selection according to some embodiments.

FIGS. 31A-31C and FIGS. 32A-32C show processes according to some embodiments.

FIG. 33 is a schematic block diagram of an apparatus according to embodiments.

### DETAILED DESCRIPTION

One or more of the embodiments described herein can take advantage of the fact that a video codec may not treat all sample positions equally. In certain aspects, this is done by making the neural network aware of the position of a sample within the picture, for instance by having different weights for different positions. In contrast to how unshared convolutional layers such as Keras LocallyConnected2D works, according to embodiments, the weights are periodically reused. In this way, it is possible for the neural network to differentiate between different sample positions in an efficient way and provide numerous advantages.

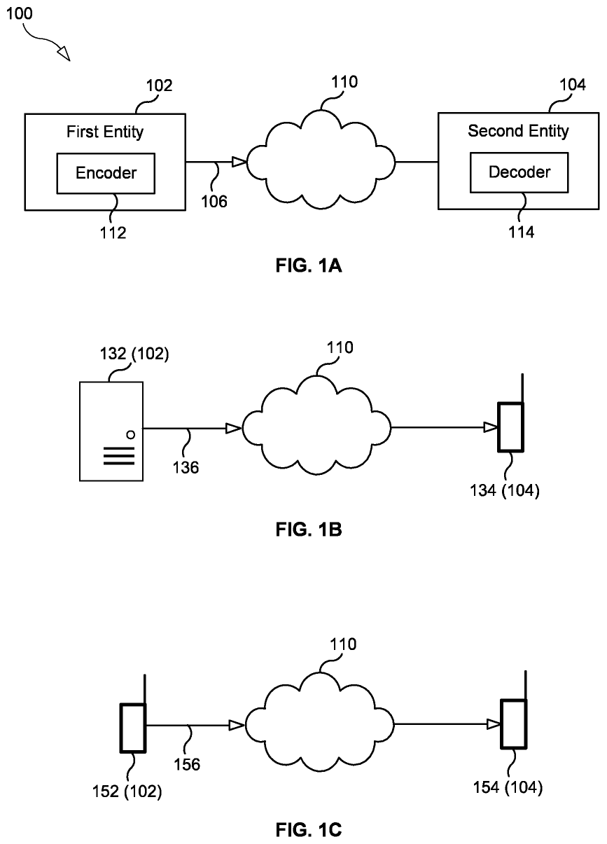

FIG. 1A shows a system 100 according to some embodiments. The system 100 comprises a first entity 102, a second entity 104, and a network 110. The first entity 102 is configured to transmit towards the second entity 104 a video stream (a.k.a., “a video bitstream,” “a bitstream,” “an encoded video”) 106.

The first entity 102 may be any computing device (e.g., a network node such as a server) capable of encoding a video using an encoder 112 and transmitting the encoded video towards the second entity 104 via the network 110. The second entity 104 may be any computing device (e.g., a network node) capable of receiving the encoded video and decoding the encoded video using a decoder 114. Each of the first entity 102 and the second entity 104 may be a single physical entity or a combination of multiple physical entities. The multiple physical entities may be located in the same location or may be distributed in a cloud.

In some embodiments, as shown in FIG. 1B, the first entity 102 is a video streaming server 132 and the second entity 104 is a user equipment (UE) 134. The UE 134 may be any of a desktop, a laptop, a tablet, a mobile phone, or any other computing device. The video streaming server 132 is capable of transmitting a video bitstream 136 (e.g., YouTube™ video streaming) towards the video streaming client 134. Upon receiving the video bitstream 136, the UE 134 may decode the received video bitstream 136, thereby generating and displaying a video for the video streaming.

In other embodiments, as shown in FIG. 1C, the first entity 102 and the second entity 104 are first and second UEs 152 and 154. For example, the first UE 152 may be an offeror of a video conferencing session or a caller of a video chat, and the second UE 154 may be an answerer of the video conference session or the answerer of the video chat. In the embodiments shown in FIG. 1C, the first UE 152 is capable of transmitting a video bitstream 156 for a video conference (e.g., Zoom™, Skype™, MS Teams™, etc.) or a video chat (e.g., Facetime™) towards the second UE 154. Upon receiving the video bitstream 156, the UE 154 may decode the received video bitstream 156, thereby generating and displaying a video for the video conferencing session or the video chat.

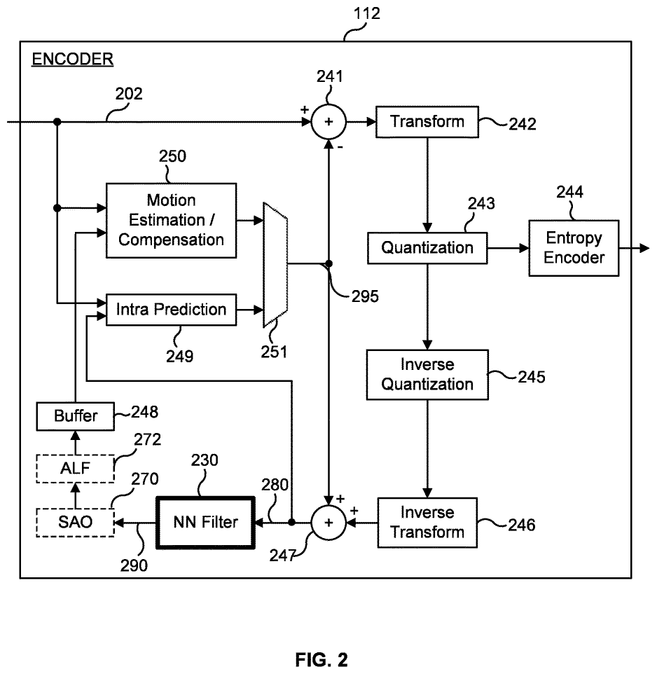

FIG. 2 shows a schematic block diagram of the encoder 112 according to some embodiments. The encoder 112 is configured to encode a block of sample values (hereafter “block”) in a video frame of a source video 202. In the encoder 112, a current block (e.g., a block included in a video frame of the source video 202) is predicted by performing a motion estimation by a motion estimator 250 from an already provided block in the same frame or in a previous frame. The result of the motion estimation is a motion or displacement vector associated with the reference block, in the case of inter prediction. The motion vector is utilized by the motion compensator 250 for outputting an inter prediction of the block.

An intra predictor 249 computes an intra prediction of the current block. The outputs from the motion estimator/compensator 250 and the intra predictor 249 are inputted to a selector 251 that either selects intra prediction or inter prediction for the current block. The output from the selector 251 is input to an error calculator in the form of an adder 241 that also receives the sample values of the current block. The adder 241 calculates and outputs a residual error as the difference in sample values between the block and its prediction. The error is transformed in a transformer 242, such as by a discrete cosine transform, and quantized by a quantizer 243 followed by coding in an encoder 244, such as by entropy encoder. In inter coding, the estimated motion vector is brought to the encoder 244 for generating the coded representation of the current block.

The transformed and quantized residual error for the current block is also provided to an inverse quantizer 245 and inverse transformer 246 to retrieve the original residual error. This error is added by an adder 247 to the block prediction output from the motion compensator 250 or the intra predictor 249 to create a reconstructed sample block 280 that can be used in the prediction and coding of a next block. The reconstructed sample block 280 is processed by a NN filter 230 according to the embodiments in order to perform filtering. The filtering may be, for example, to combat blocking artifacts. The output from the NN filter 230, i.e., the output data 290, is then temporarily stored in a frame buffer 248, where it is available to the intra predictor 249 and the motion estimator/compensator 250. In some embodiments, the encoder 112 may include SAO unit 270 and/or ALF 272. The SAO unit 270 and the ALF 272 may be configured to receive the output data 290 from the NN filter 230, perform additional filtering on the output data 290, and provide the filtered output data to the buffer 248.

Even though, in the embodiments shown in FIG. 2, the NN filter 230 is disposed between the SAO unit 270 and the adder 247, in other embodiments, the NN filter 230 may replace the SAO unit 270 and/or the ALF 272. In some embodiments, the NN filter 230 may be after SAO unit 270 and before the ALF 272, or after both. Alternatively, in other embodiments, the NN filter 230 may be disposed between the buffer 248 and the motion compensator 250. Furthermore, in some embodiments, a deblocking filter (not shown) may be disposed between the NN filter 230 and the adder 247 such that the reconstructed sample block 280 goes through the deblocking process and then is provided to the NN filter 230. In embodiments, the NN output can be combined with a deblocking output. For instance, where the output of the NN is:

outNN=f(rec,other inputs to NN),

and the output from the deblocking filter is:

$$outDBLK = deblock ( rec ) ,$$

then the combination combNN is:

$$combNN = c * outNN + ( 1 - c ) * outDBLK .$$

Here, c is a number between 0 and 1 that can be signaled from the encoder to the decoder, and where * is a scalar multiplication. This can ensure that the combNN output has either gone through the NN filter (for instance if c=1) or through the deblocking filter (c=0) or a weighting between two filtered output (for instance if c=0.5 we have that combNN is the average of outNN and outDBLK). In certain aspects, this combNN is then fed to SAO unit 270 of FIG. 2. The foregoing discussion regarding NN filter 230 filter placement and functionality may also be applicable to NN filter 330 as shown in FIG. 2. Alternatively, the NN filter 230 may instead be placed as a post filter, i.e., it will not affect samples in the display buffer 248 used for prediction.

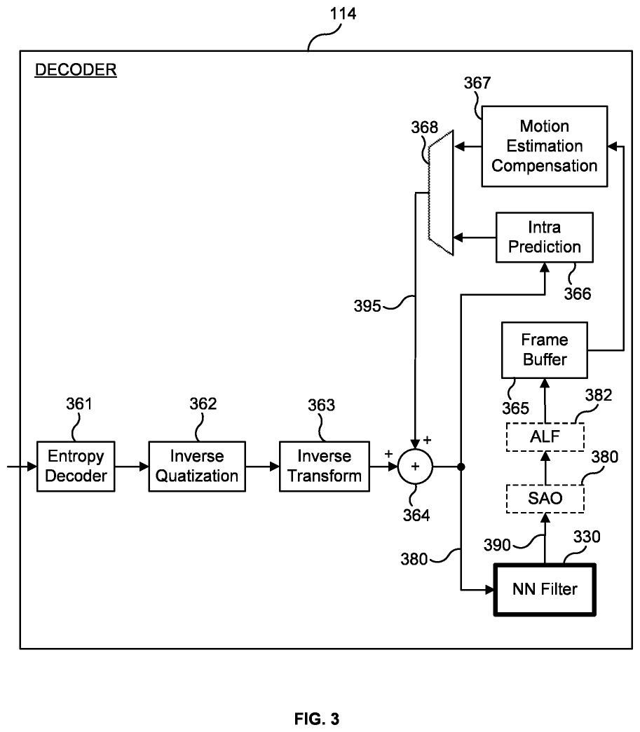

FIG. 3 is a schematic block diagram of the decoder 114 according to some embodiments. The decoder 114 comprises a decoder 361, such as entropy decoder, for decoding an encoded representation of a block to get a set of quantized and transformed residual errors. These residual errors are dequantized in an inverse quantizer 362 and inverse transformed by an inverse transformer 363 to get a set of residual errors. These residual errors are added in an adder 364 to the sample values of a reference block. The reference block is determined by a motion estimator/compensator 367 or intra predictor 366, depending on whether inter or intra prediction is performed.

A selector 368 is thereby interconnected to the adder 364 and the motion estimator/compensator 367 and the intra predictor 366. The resulting decoded block 380 output form the adder 364 is input to a NN filter unit 330 according to the embodiments in order to filter any blocking artifacts. The filtered block 390 is output form the NN filter 330 and is furthermore preferably temporarily provided to a frame buffer 365 and can be used as a reference block for a subsequent block to be decoded. The frame buffer (e.g., decoded picture buffer (DPB)) 365 is thereby connected to the motion estimator/compensator 367 to make the stored blocks of samples available to the motion estimator/compensator 367. The output from the adder 364 is preferably also input to the intra predictor 366 to be used as an unfiltered reference block. In some embodiments, the decoder 114 may include SAO unit 380 and/or ALF 372. The SAO unit 380 and the ALF 382 may be configured to receive the output data 390 from the NN filter 330, perform additional filtering on the output data 390, and provide the filtered output data to the buffer 365.

Even though, in the embodiments shown in FIG. 3, the NN filter 330 is disposed between the SAO unit 380 and the adder 364, in other embodiments, the NN filter 330 may replace the SAO unit 380 and/or the ALF 382. Alternatively, in other embodiments, the NN filter 330 may be disposed between the buffer 365 and the motion compensator 367. Furthermore, in some embodiments, a deblocking filter (not shown) may be disposed between the NN filter 330 and the adder 364 such that the reconstructed sample block 380 goes through the deblocking process and then is provided to the NN filter 330. Alternatively, in some embodiments, the NN Filter 330 may be used as a post filter. It will then be placed between the frame buffer and the display/output, and the samples processed by the NN filter will not used for prediction by the motion estimation compensation 367.

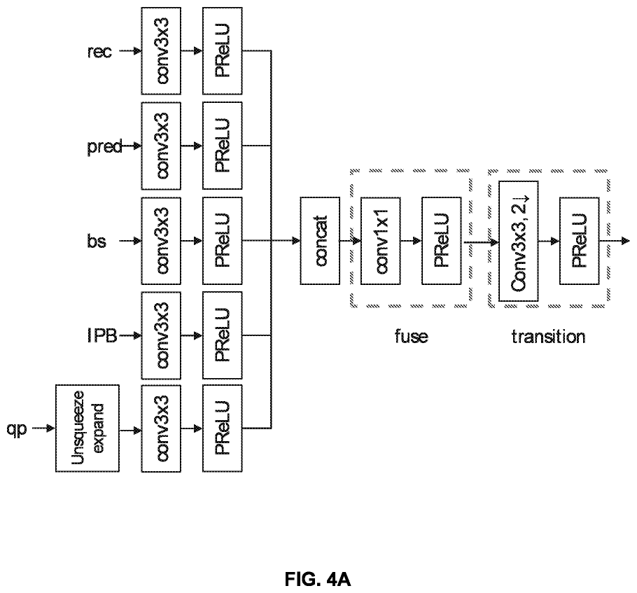

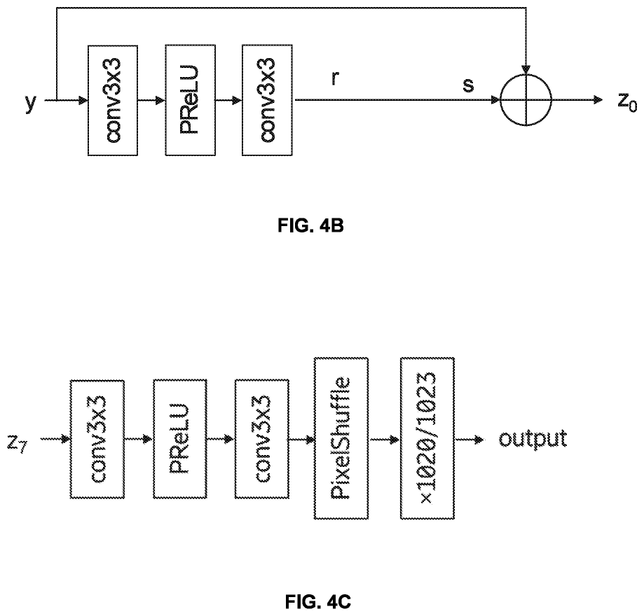

According to embodiments, one or more of the arrangements shown in FIGS. 4A, 4B, and/or 4C can be used in the NN filter 230, 330 shown in FIGS. 2 and 3 and system 100.

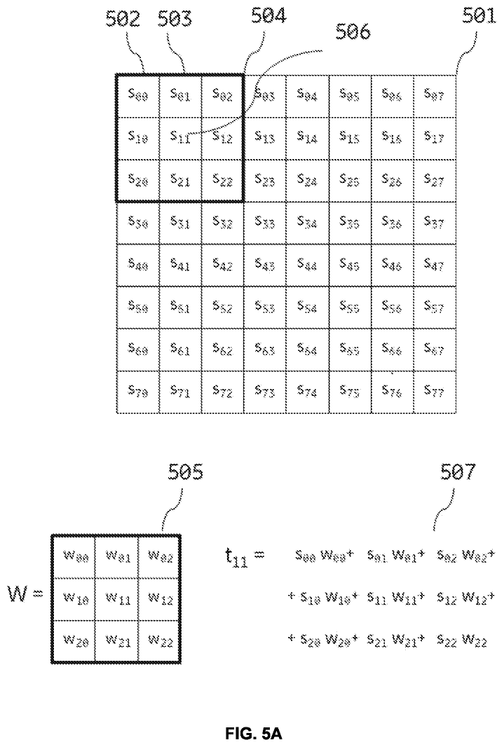

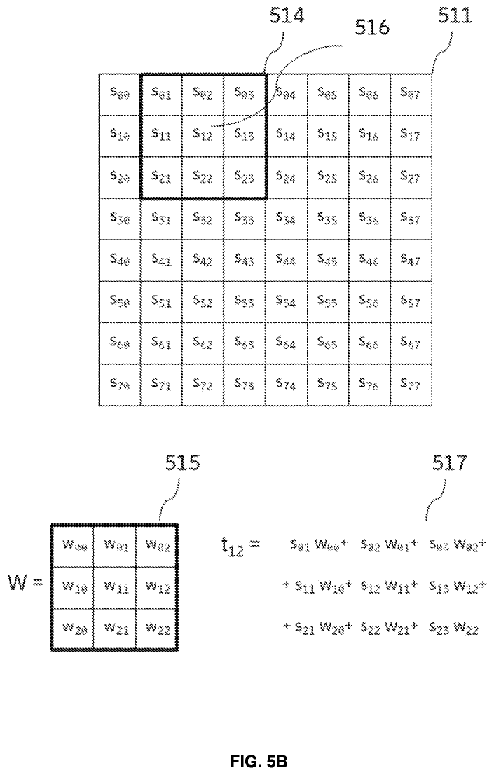

As illustrated with respect to FIGS. 4A-4C, for example, NN solutions can be based on convolutional neural networks (CNNs), such as neural networks that are built using building blocks named conv3×3, conv1×1, conv3×3, 2↓, etc. The functionality of such blocks can be illustrated as shown in FIG. 5A, where a conv3×3 with one input channel and one output channel is illustrated. An 8×8 block of input samples (501) containing samples s₀₀ (502), s₀₁ (503), etc. is to be processed by the 3×3 weight matrix (505). The terms weight matrix and weight tensor can be used interchangeably. The term sample here may refer, for example, to inputs to the neural network our output signals from previous neural network layers.

Starting with the sample s₁₁ (506), the 3×3 neighborhood (504) centered around sample s₁₁ (506) is multiplied elementwise with the weight matrix W (505). The result is the weighted sum t₁₁ (507):

$${t}_{11} = {s}_{00} {w}_{00} + {s}_{01} {w}_{01} + {s}_{02} {w}_{02} ++ {s}_{10} {w}_{10} + {s}_{11} {w}_{11} ++ {s}_{12} {w}_{12} + {s}_{20} {w}_{20} + {s}_{21} {w}_{21} + {s}_{22} {w}_{22} .$$

A bias term is added to the weighted sum t₁₁ and the result is then fed through a non-linear activation function, e.g., a parametric rectified linear unit PReLU:

$${u}_{11} = PReLU ( {t}_{11} + bias ) ,$$

and the output value u₁₁ is then placed in the output 8×8 block (not shown) in the position corresponding to that of s₁₁ in the input block. Sometimes there is more than one output channel, and then this procedure is repeated again with another weight matrix W and another PReLU function. Likewise, sometimes there is more than one input channel, and then the weight matrix W becomes a three-dimensional tensor. For the simplicity of presentation however, FIG. 5A only shows a CNN with one channel in and one channel out.

FIG. 5B illustrates the processing of the next element s₁₂ (516). Again, the 3×3 neighborhood (514) centered around the element s₁₂ (506) is used together with the weight matrix W (505) to create the weighted sum (517). Here, the same weight matrix is used no matter which sample is the center sample, which means that weight matrices W (505) and W (515) are identical. This reuse of weights can be an important aspect of convolutional neural networks, since it means that the number of parameters in the network can be kept low compared to a fully connected neural network. It also means that a single weight, such as w₁₀, gets to be trained on many more training examples (i.e., many more sample positions) than if the network was fully connected. This makes the training quicker and makes it converge more easily. To reuse the weights in different positions of the picture also often makes sense in many practical applications. For example, in raw image data, there may be no unique features with respect to samples that have, e.g., an odd x-coordinate that make them behave differently compared to samples that have an even x-coordinate.

For images that are the output of a video decoder, this is often no longer true. Many aspects of the VVC codec (e.g., transform size, partitioning) mean that the decoded output picture is no longer independent of position within the image. As an example, samples that are close to a 4×4 boundary are much more prone to exhibiting blocking artifacts than are samples that are in the center of a 4×4 block. However, using a fully connected layer or an unshared convolutional layer such as Keras LocallyConnected2D would mean that the number of parameters would grow extremely quickly as a function of the image size, which is not feasible. According to embodiments, a solution is provided in which weights are repeatedly reused.

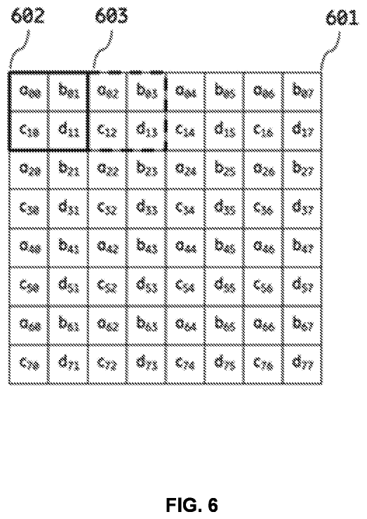

FIG. 6 illustrates aspects of one or more embodiments. In this example, for illustration simplification purposes, instead of assuming that the picture is divided into 4×4 blocks it is assumed that the 8×8 picture (601) in FIG. 6 is divided into 2×2 blocks. For instance, the samples a00, b01, c10 and d11 together form a 2×2 block (602). Likewise, the samples a02, b03, c12 and d13 together form a 2×2 block (603). Note that in every 2×2 block, the top left sample is always denoted a, the top right is always denoted b, the bottom left is always denoted c and the bottom right is always denoted d. This division into blocks with repeating sample denotations can be repeated across the picture 601.

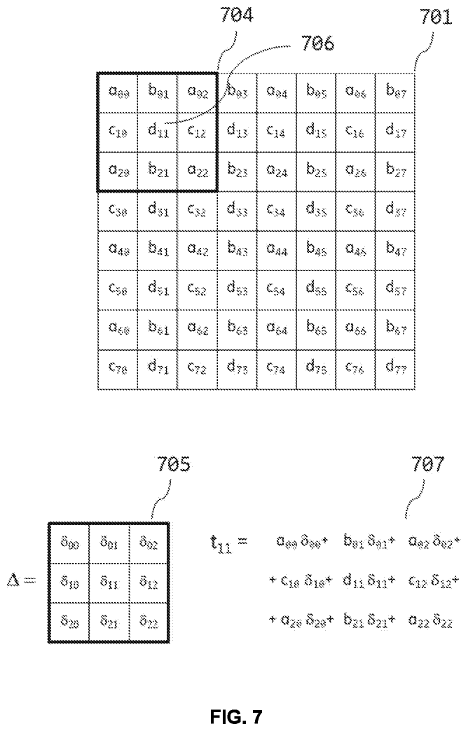

FIG. 7 illustrates how filtering can be performed according to one embodiment of the present invention. When processing the position (1,1) in a set of inputs (e.g., in a CTU or other block of values/samples 701), which is represented by the sample d₁₁ (706), the 3×3 neighborhood (704) is used together with a weight matrix A (705) to produce the weighted sum t₁₁ (707) according to

$${t}_{11} = {a}_{00} {δ}_{00} + {b}_{01} {δ}_{01} + {a}_{02} {δ}_{02} ++ {c}_{10} {δ}_{10} + {d}_{11} {δ}_{11} + {c}_{12} {δ}_{12} ++ {a}_{20} {δ}_{20} + {b}_{21} {δ}_{21} + {a}_{22} {δ}_{22} .$$

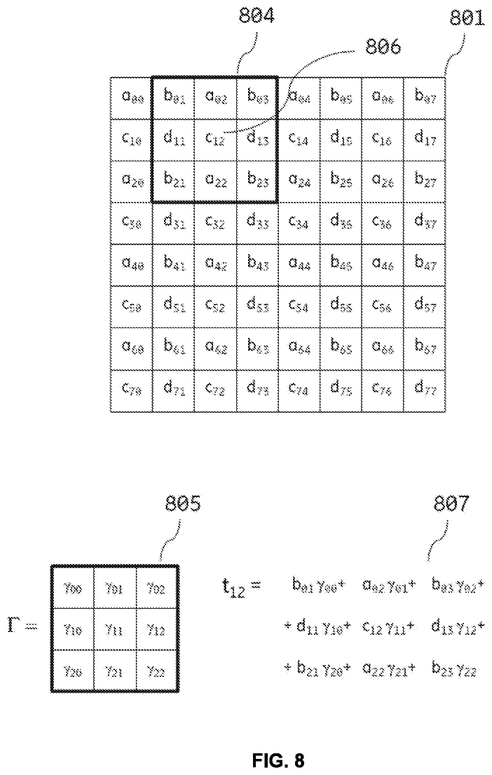

Similarly, FIG. 8 illustrates the processing of the sample in the position (1,2), which is represented by the next sample to the right, c₁₂ (806), in the set of inputs 801. Again, a 3×3 neighborhood (804) is used together with a weight matrix F (805) to produce the weighted sum t₁₂ (807) according to

$${t}_{12} = {b}_{01} {γ}_{00} + {a}_{02} {γ}_{01} + {b}_{03} {γ}_{02} ++ {d}_{11} {γ}_{01} + {c}_{12} {γ}_{11} + {d}_{13} {γ}_{12} ++ {b}_{21} {γ}_{20} + {a}_{22} {γ}_{21} + {b}_{23} {γ}_{22} .$$

However, and according to some embodiments, the weight matrix F (805) is not the same as the weight matrix A (705). The weight matrix A (705) is reserved only for convolutions when the middle sample is a d-sample, i.e., a sample that has the bottom right position within the 2×2 blocks. Likewise, the weight matrix F (805) is reserved for situations when the middle sample is a c-sample, i.e., a sample that has the bottom left position within its 2×2 block. Furthermore, but not shown, a weight matrix A is used for situations when the middle sample is an a-sample, i.e., a sample that has the top left position within its 2×2 block, and a weight matrix B is used for situations when the middle sample is a b-sample, i.e., a sample that has the top right position within its 2×2 block. It should be noted that different not only different weight tensors, but also different bias terms may be used in all these cases. Hence, if the middle sample is an a-sample, the bias value bias_{α} may be used, if the middle sample is a b-sample, the bias value bias_{β} may be used, and for c-samples and d-samples bias_{γ} and bias_{δ} may be used respectively. It should also be noted that if the convolution is 4×4 rather than 3×3, there is no exact center sample. However, in this case the switching of weight tensors can be done with reference another sample of 4×4 neighborhood, such as the top left sample. In the following it we will describe mainly how weight tensors are treated, but a part of the present invention is that bias values may be treated in a similar way.

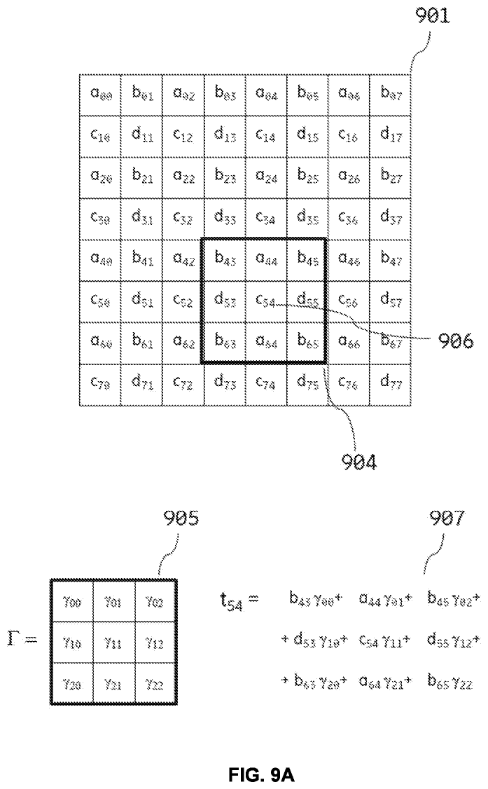

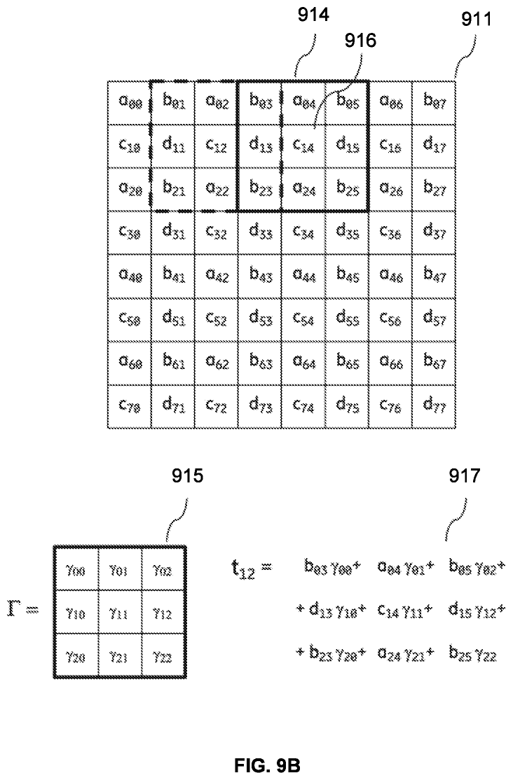

Referring now to FIG. 9A, an example is provided where the center sample of the 3×3 neighborhood (904) is the sample c₅₄ (906) in block 901. Since it is a c-sample, i.e., has the position bottom left within its 2×2 block in this example, its 3×3 neighborhood (904) will be multiplied by the F matrix (905) to form the weighted sum (907). Note that this matrix 905 is identical to the matrix (805), since it deals with the same type of sample (bottom left samples, c samples in this example). This is in contrast to how an unshared convolutional layer such as Keras LocallyConnected2D works—in that case these matrices would be different. It should be noted that the specific letters and corresponding positions used in the examples are for illustration purposes only.

According to some embodiments, the coefficients in the matrix F will always be multiplied by samples of the same kind. As an example, the coefficient γ₀₀ in the sum (907) will be multiplied by b₄₃, which is of the type “top right.” Likewise, in FIG. 8, the coefficient γ₀₀ in the sum (807) will be multiplied by b₀₁, which is again a sample of the “top right” kind. In certain aspects, this makes it possible for the weights in the different matrices to be specialized to specific positions within the 2×2 blocks. As one example, if bottom left samples are always darker than other samples, the present invention can compensate for that by increasing the weights in the F matrix. This is not possible with a conventional convolutional layer, nor is it possible with a LocallyConnected2D layer, since different matrices are used everywhere.

Referring now to FIG. 9B, and according to some embodiments, a matrix may be reused where two neighborhoods of block 911 have overlapping positions. In the example of FIG. 9B, the region 914 centered around sample c14 (916) overlaps with region 804 shown in FIG. 8, which is also marked in FIG. 9B using a dashed demarcation. As illustrated, they use the same F matrix since they are both centered around a c-sample.

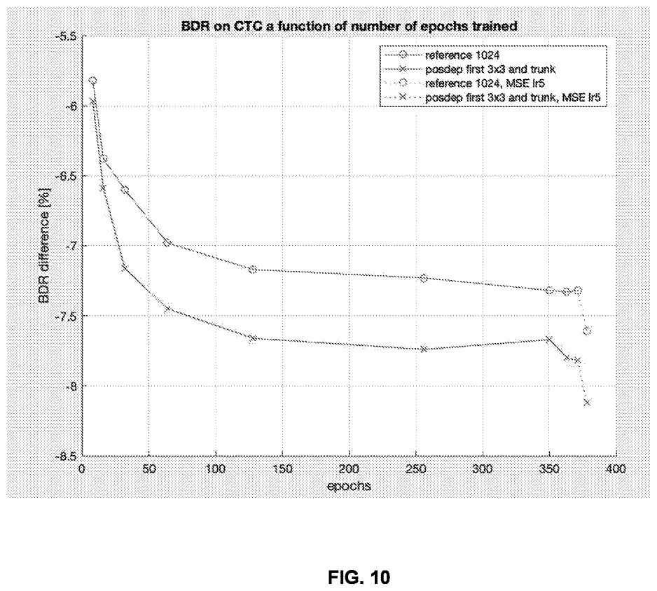

For illustration simplification purposes, examples are illustrated using the case where there is one input channel and one output channel, but it should be noted that the embodiments described herein can be generalized to any number of input- and output-channels. For example, in a test implementation shown in FIG. 10, 96 input channels and 96 output channels were used with position dependent convolutional layers. Also, 2×2 has been used as a simplification, but pictures can use different sizes. For example, VVC video decoded pictures are more likely to exhibit regularity on a 4×4 sample grid. However, due to the downsampling in the transition part of the head, a 4×4 regularity in the input data corresponds to 2×2 regularity in the trunk part of the neural network.

According to some embodiments, the first conv3×3 in the trunk illustrated in FIG. 4B can be implemented in a position dependent way in Pytorch using the following code:
batch_dim =x.size(dim=0)
ch_dim =x.size(dim=1)
y_dim =x.size(dim=2)
x_dim =x.size(dim=3)
x_tl =x
x_tr =torch.zeros(batch_dim, ch_dim, y_dim, x_dim+1).cuda( )
x_tr[:, :, :, 1:x_dim+1]=x[:, :, :, 0:x_dim]
x_bl =torch.zeros(batch_dim, ch_dim, y_dim+1, x_dim).cuda( )
x_bl[:, :, 1:y_dim+1, :]=x[:, :, 0:y_dim, :]
x_br =torch.zeros(batch_dim, ch_dim, y_dim+1, x_dim+1).cuda( )
x_br[:, :, 1:y_dim+1, 1:x_dim+1]=x[:, :, 0:y_dim, 0:x_dim]
y_tl =self.conv1_tl(x_tl)
y_tr =self.conv1_tr(x_tr)[:, , :, 1:((x_dim//2)+1)]
y_bl =self.conv1_bl(x_bl)[:, , 1:((y_dim//2)+1), :]
y_br =self.conv1_br(x_br)[:, :, 1:((y_dim//2)+1), 1:((x_dim//2)+l)]
y=torch.zeros(y_tl.size(dim=0 , y_tl.size(dim=1), y_tl.size(dim=2)*2,
y_tl.size(dim=3)*2).cuda( )
y[:, , O:x.size(dim=2):2, 0:x.size(dim=3):2]=y_tl
y[:, , O:x.size(dim=2):2, 1:x.size(dim=3):2]=y_tr
y[:, , 1:x.size(dim=2):2, 0:x.size(dim=3):2]=y_bl
y[:, , 1:x.size(dim=2):2, 1:x.size(dim=3):2]=y_br
z =self.relu(y)
   Here, tl stands for “top left”, tr for “top right”, bl for “bottom left” and br for “bottom right.” The conv1_tl, conv1_tr, conv1_bl and conv1_br can be implemented using a regular CNN layer with stride 2:
self.convl_tl=nn.Conv2d(in_channels, no_features, kernel_size, stride=2, padding=1)
self.conv1_tr=nn.Conv2d(in_channels, no_features, kernel_size, stride=2, padding=1)
self.conv1_bl =nn.Conv2d(in_channels, no_features, kernel_size, stride=2, padding=1)
self.conv1_br=nn.Conv2d(in_channels, no_features, kernel_size, stride=2, padding=1)
   While the first conv3×3 in the trunk is used as an example here, embodiments are applicable to other parts of the NN (e.g., head or tail) and other convolutional layers.

FIG. 10 shows the performance of the position dependent NN of one or more embodiments compared to a regular implementation without position dependent convolutions. The curve with circles in FIG. 10 shows the performance of a NN such as the one in JVET-AB0053 with traditional convolutions. The solid line shows the performance for L1 loss function and learning rate 1e-4, and the dotted line shows the performance at the end of the training when a mean square error (MSE) loss function is used together with learning rate 1e-5 to fine-tune the training. Lower BDR difference is better in the diagram, and the final circle indicates a bit rate reduction of −7.61%. The curve with crosses in FIG. 10 shows the performance of a NN according to embodiments. Again, the solid line shows the performance for L1 loss function and learning rate 1e-4, and the dotted line shows the performance at the end of the training when an MSE loss function is used together with learning rate 1e-5 to fine-tune the training. As can be seen in the diagram, the rightmost cross at −8.12% is significantly lower (better) than the right-most circle. The difference is −8.12%−(−7.61%)=−0.51%. Yet, the same number of multiply-accumulate (MAC) operations are performed in both cases, meaning that the complexity in terms of kMACs/sample remains the same.

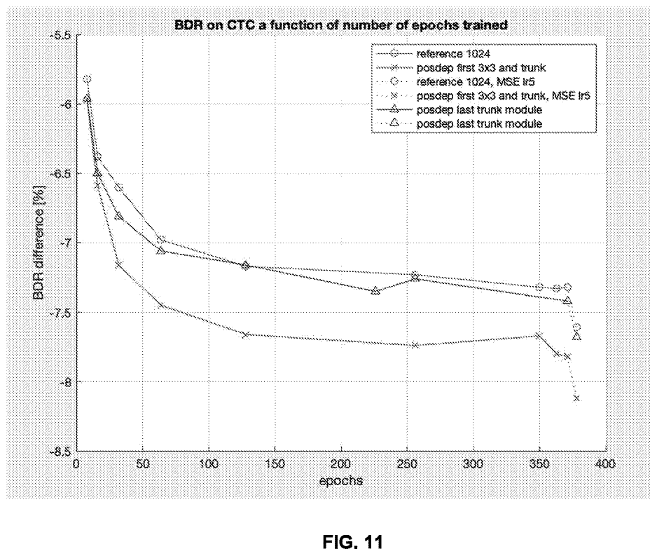

In the example above, four matrices are needed instead of just one, and also four bias terms are needed instead of just one, so the number of parameters goes up roughly by a factor of four. In some circumstances, this parameter count increase may be a reasonable trade-off for a BD-rate gain of 0.5%. However, one may want to decrease the number of parameters. Therefore, in another embodiment, instead of using the position dependent convolutions in all conv3×3 layers in the trunk, they are only used in a few of the eight residual blocks. As an example, FIG. 11 shows the performance of using position dependent convolution only in the last residual block out of the eight. Other subsets may be selected. Here, in addition to the previous curves, a curve is marked with triangles that shows the performance of the method where position dependent filtering happens only in the last residual block of the trunk. As can be seen, this curve is somewhere in-between the two other curves, meaning that some of the gain can be preserved, whereas the number of parameters is substantially reduced.

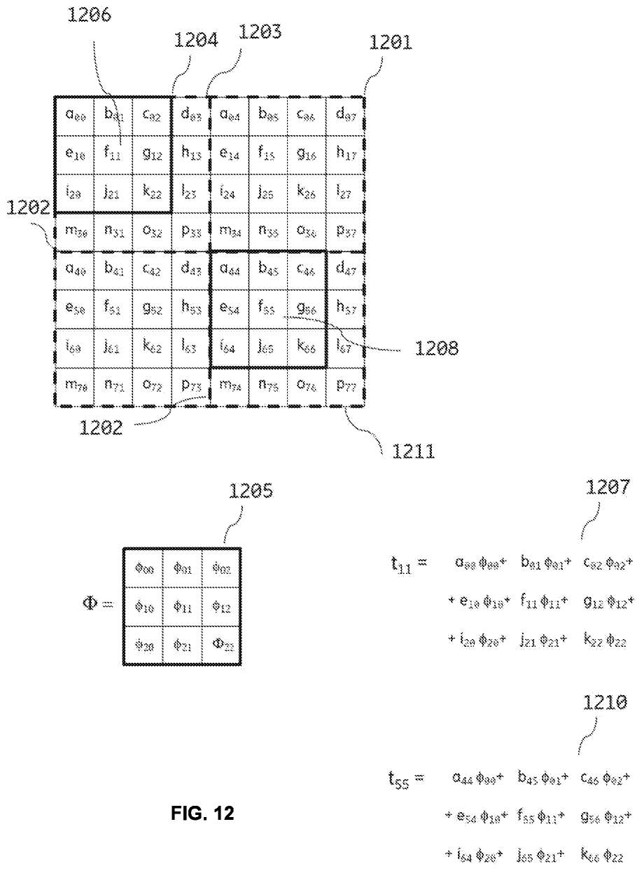

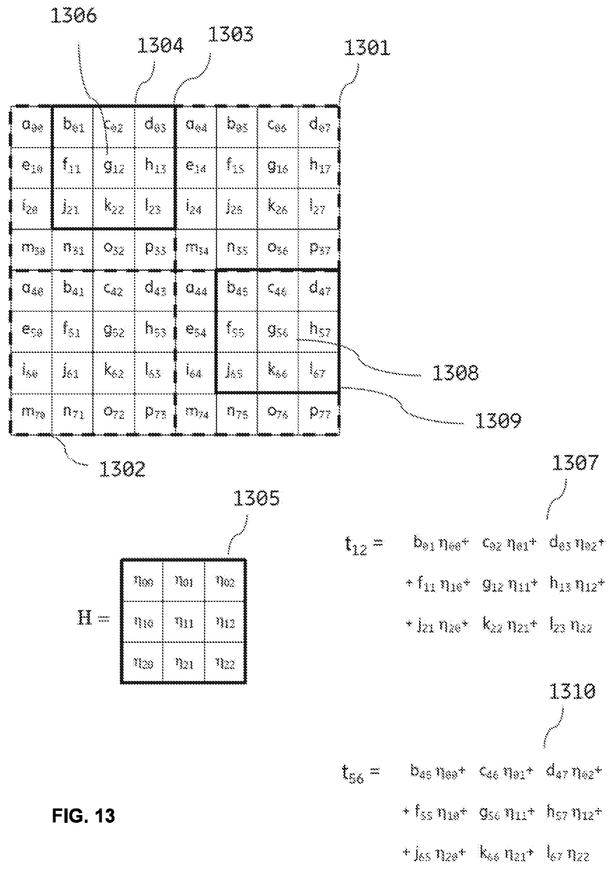

In the above example, the weights in the trunk are reused after 2×2 samples. For instance, with reference to FIG. 7, the same matrix A (705) is used when the filter is centered on the position d₁₁ (706) as when centered on position d₁₃ two samples to the right, or when centered on the position d₃₁, two samples down. It is also possible to reuse the weights more seldom, such as every 4×4 samples, as is shown in FIG. 12 and with the set of inputs 1201. Here, the 8×8 sample block (1201) is divided into four 4×4 blocks indicated by dashed dividers (1202). These four blocks are examples of repeater blocks, since the weight tensors are repeated (reused) among them. As an example, sample point f₁₁ (1206) is situated one step to the right and one step down in its 4×4 block (1203), and sample point f₅₅ (1208) is situated in the same relative position (one step to the right and one step down) in its 4×4 repeater block (1211). Hence the same weight tensor Φ (1205) will be used both when processing t₁₁ (1207) (with the convolution filter centered around f₁₁ (1206)) and when processing t₅₅ (1210) (with the convolution filter centered around f₅₅ (1208)). Compared to the case when a 2×2 repeater block is used, using 4×4 repeater blocks may increase the number of parameters needed, thereby increasing memory consumption. By contrast, as is shown in FIG. 13 and block 1301, when filtering another position where the filter is centered around a position g₁₂ (1306) with another position inside its 4×4 repeater block (1303) to produce t₁₂ (1307), a different weight tensor H (1305) is used, and this weight tensor is instead shared with other positions with similar positions such as g₅₆ (1308) producing t₅₆ (1310).

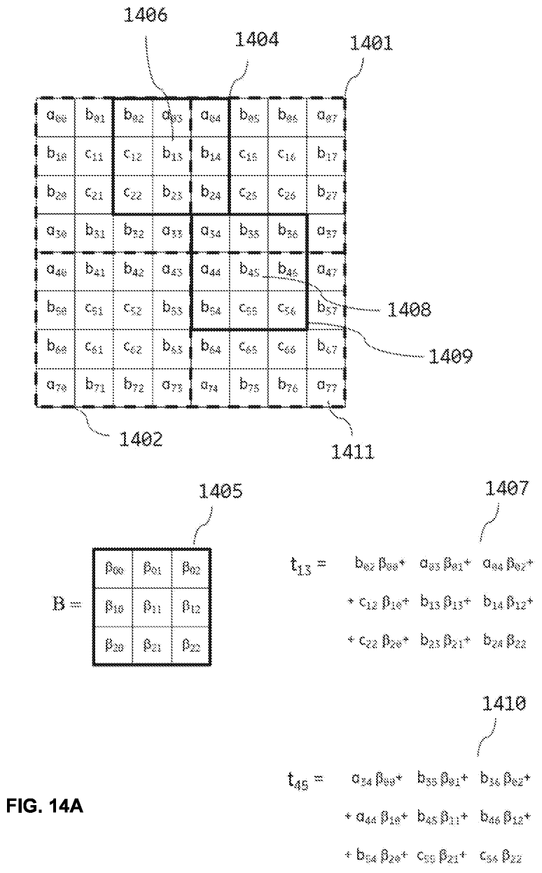

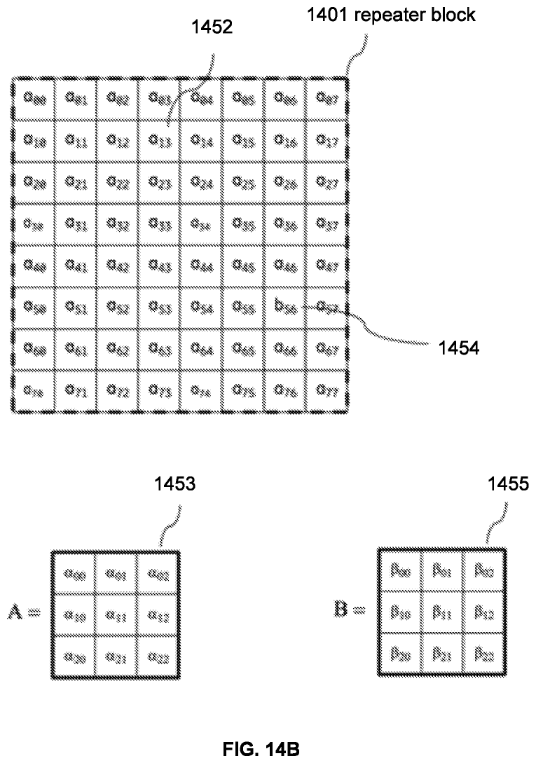

According to some embodiments, weight tensors in different positions inside the repeater block (or subblock) can be grouped together. An example is shown in FIG. 14A, where samples 1401 are grouped according to how far away they are from a block boundary. Samples in the corners of a repeater block such as a₇₇ (1411), touching two dashed dividers (1420), are marked with “a” and all these samples use the same weight matrix A when the filter is centered on them. Samples at the edges of a repeater block but not at the corners, thus touching exactly one dashed divider, such as is the case for sample b₁₃ (1406), use a different weight tensor B (1405). As an example, B is used both when the convolution filter is centered on sample b₁₃ (1406) and when the convolution filter is centered on sample b₄₅ (1408), since both are edge samples. Finally, samples in the middle of the repeater block, not touching any dashed divider, are denoted “c” and are filtered using a third weight tensor Γ. By sharing filters in this way, memory consumption can be lowered while still preserving a relevant position dependency, in this case distance to an edge. Other relevant position dependencies may be used. In some embodiments, various patterns of weight tensor can be reused. With reference to FIG. 14B as an example, an 8×8 repeater block 1451 is used. When centered on an a-value, such as a₁₃ (1452), the weight tensor A (1453) is used. This could be reused for the majority (or nearly all) positions. However, there may be limited exceptions in a given embodiment or application. For instance, here, there is only one exception—a value centered on b₅₆ (1454), in which case the weight tensor B (1455) is used. That is, one tensor may be used for a majority—but not all—positions.

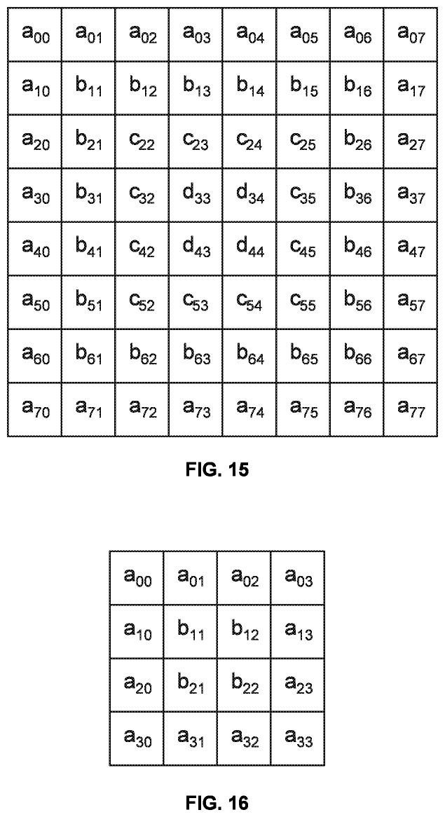

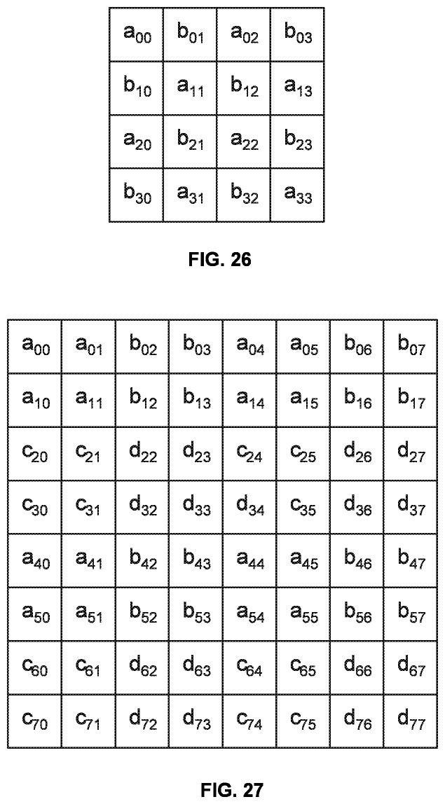

Two other examples of shared weight matrices inside a repeater matrix are shown in FIG. 15 and FIG. 16. In FIG. 15, the repeater block is of size 8×8, and yet only four different weight tensors are used, one for every type of sample (a, b, c and d). In FIG. 16, the repeater block is of size 4×4, and only two different weight tensors are used, one for a-samples and one for b-samples. Yet another example is a repeater matrix in a checkerboard pattern as is shown in FIG. 26. Switching matrices on a per-sample basis may be taxing on some implementations. Therefore, in another embodiment, a repeater matrix that keeps the same weights in a 2×2 area can be used, as illustrated in FIG. 27. In some embodiments, three dimensional repeater blocks may be used.

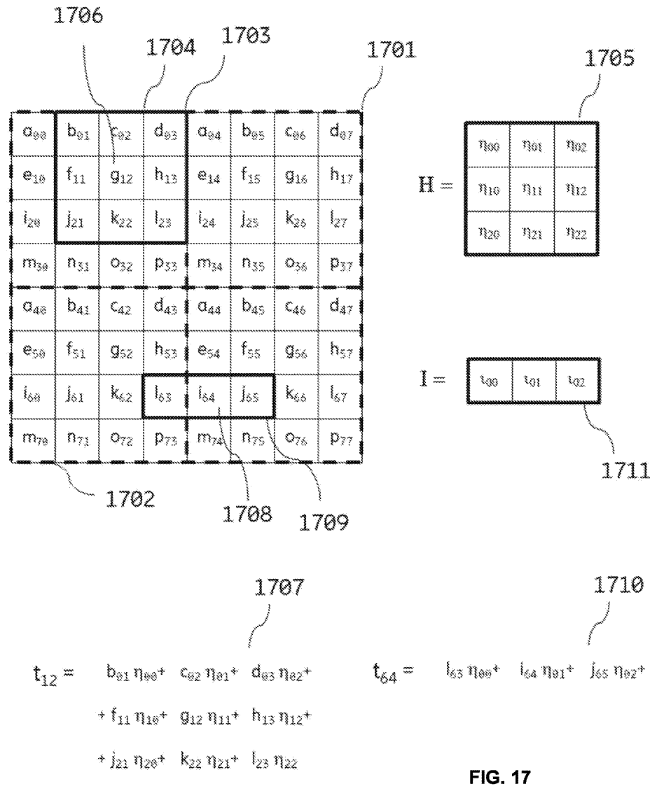

In another embodiment, the weight tensors may not only have different coefficients but may also be of different shapes for different positions within the repeater block. An example of this is shown in FIG. 17 with the set of inputs 1701. Here, when calculating t₁₂ (1707), the filter region (1703) that is centered on sample g₁₂ (1706) is of shape 3×3, and it is using a 3×3 weight tensor (1705). However, when calculating t₆₄ (1710), the filter region (1709) that is centered on sample i₆₄ (1708) is of shape 1×3 and it is using a 1×3 weight tensor (1711). By having smaller filter regions in some positions, complexity in terms of kMACs can be lowered, and the number of parameters (number of tensor weights) can be lowered too.

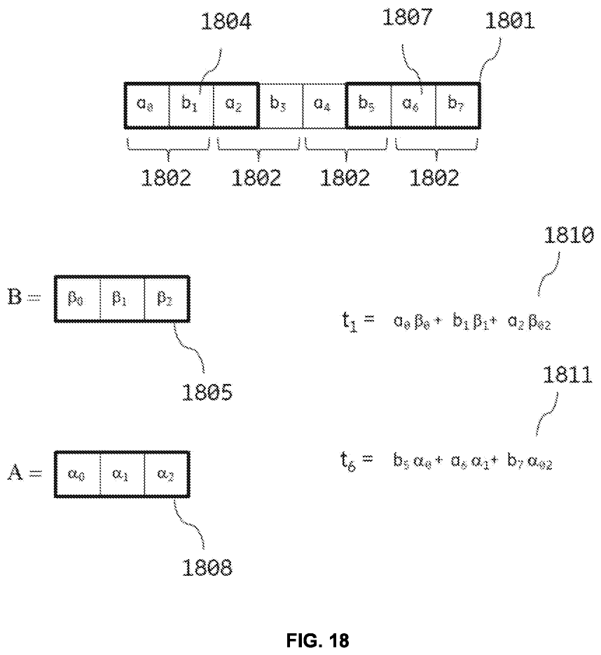

In some embodiments, the signal to be compressed is not two-dimensional, but instead one-dimensional. Some examples are sound signals, radio signals, text, etc. Also, in these cases a CNN can be enhanced using position dependent filtering. An example is shown in FIG. 18. Here, an 8-sample frame (1801) is divided into four repeater blocks (1802) of 2 samples each. When the convolution filter is centered on bᵢ(1804), weight tensor B (1805) is used, and the same weight tensor is used for all samples marked b (bi, b₃, b₅ and b₇). When the convolution filter is instead centered on a sample named “a′” such as a₆ (1807), another weight tensor A (1808) is used, and the same is also used for (a₀, a₂, and a₄).

Although labeled with different numbers in the various figures, the set of inputs (e.g., blocks or frames) 801, 901, . . . 1801 that are used may be the same in different figures according to embodiments. That is, though shown with different numberings, different figures may show different filtering steps (or sub-steps) applied to the same inputs. By way of example, FIG. 9 illustrates the selection of a different neighborhood (904) than the neighborhood (804) illustrated in FIG. 8, but they may be selected in the same set of inputs 801, 901.

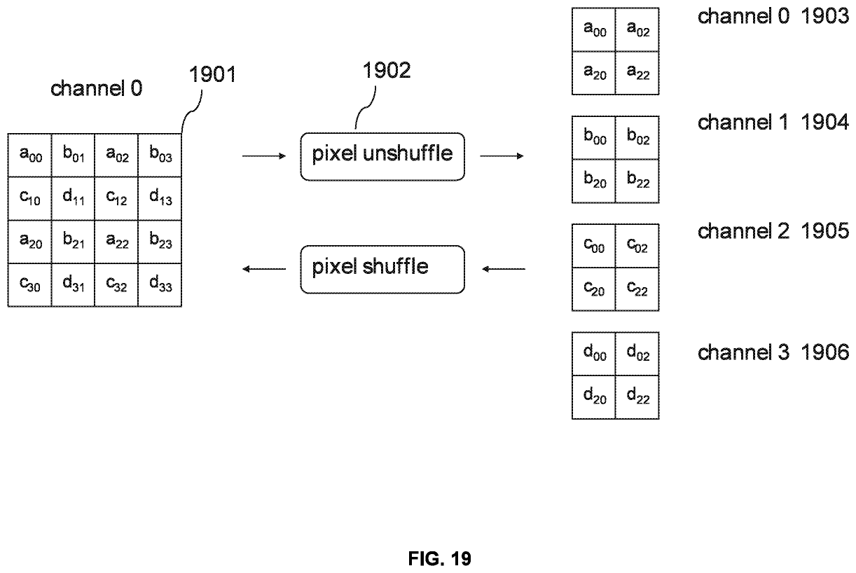

Pixel shuffle and pixel unshuffle can be built-in functions in certain modern neural network training frameworks, such as PyTorch (torch.nn.PixelShuffle and torch.nn.PixelUnshuffle). FIG. 19 shows an example of how pixel unshuffle and pixel shuffle can be implemented. In this example, a one-channel sample block of size 4×4 (1901) undergoes pixel unshuffle (1902). This creates a four-channel output, where all the samples with even x- and y-coordinates end up in the first channel (channel 0, 1903), i.e., all samples named “a” in the original sample block 1901 end up in channel 0 (1903). Likewise, all samples named “b” end up in channel 1 (1904), all samples named “c” end up in channel 2 (1905), and all samples named “d” end up in channel 3 (1906). According to some embodiments, pixel shuffle and pixel unshuffled can be used to perform filtering.

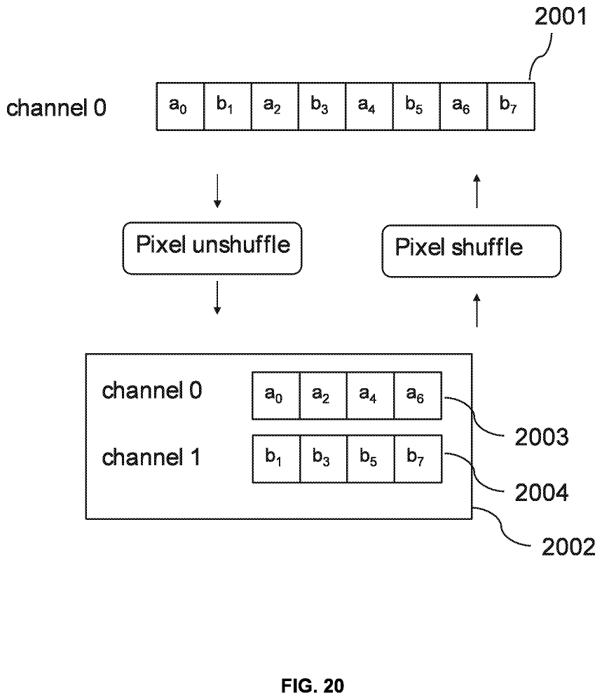

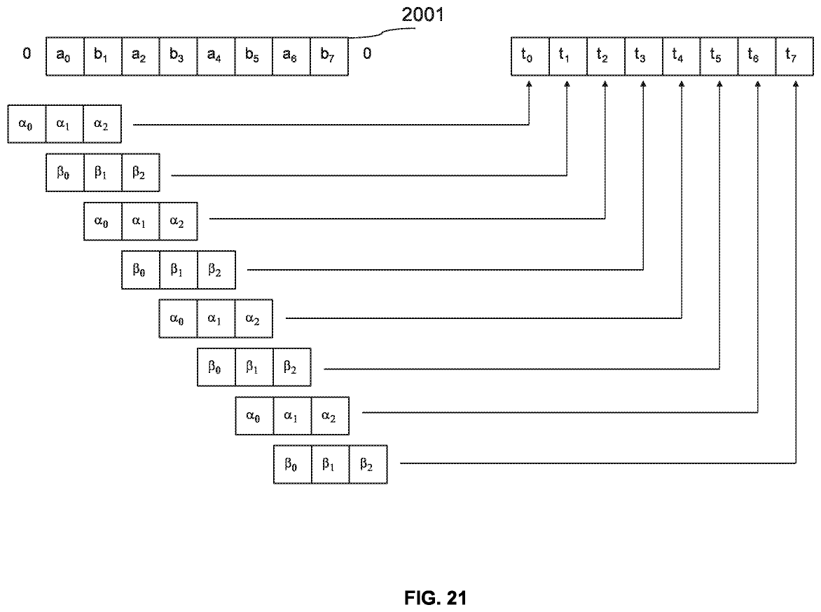

In the one-dimensional case, pixel shuffle works as shown in FIG. 20. An example is provided using a one-dimensional case; however, the same principle holds for the two-dimensional case. Here, an input block (2001) of one channel that undergoes pixel unshuffle results in an output tensor (2002) containing two channels: channel 0 (2003) will hold samples from the block 2001 with even x-coordinates (“a” samples), and channel 1 (2004) will hold samples with odd x-coordinates (“b” samples). The 1×8 sample block 2001 from FIG. 20 can be processed with a positional dependent NN filter according to certain embodiments. This is illustrated in the example of FIG. 21. Here, the 1×8 sample block is processed with one weight tensor A=[α₀α₁α₂] when the convolution is centered on an even sample (named “a”), and with another weight tensor B=[β₀ β₁ β₂] when the convolution is centered on an odd sample (named “b”). When the convolution goes outside the block, such as when centered on sample a₀, it is padded with zeros in this example. This results in:

$${t}_{0} = {α}_{0} 0 + {α}_{1} {a}_{0} + {α}_{2} {b}_{1} ,$$

$${t}_{1} = {β}_{0} {a}_{0} + {β}_{1} {b}_{1} + {β}_{2} {a}_{2} ,$$

$${t}_{2} = {α}_{0} {b}_{1} + {α}_{1} {a}_{2} + {α}_{2} {b}_{3} ,$$

$${t}_{3} = {β}_{0} {a}_{2} + {β}_{1} {b}_{3} + {β}_{2} {a}_{4} ,$$

$${t}_{4} = {α}_{0} {b}_{3} + {α}_{1} {a}_{4} + {α}_{2} {b}_{5} ,$$

$${t}_{5} = {β}_{0} {a}_{4} + {β}_{1} {b}_{5} + {β}_{2} {a}_{6} ,$$

$${t}_{6} = {α}_{0} {b}_{5} + {α}_{1} {a}_{6} + {α}_{2} {b}_{7} ,$$

$${t}_{7} = {β}_{0} {a}_{6} + {β}_{1} {b}_{7} + {β}_{2} 0 .$$

Adding the bias term and applying PReLU, the result is:

$${u}_{0} = PReLU ( {t}_{0} + {bias}_{0} ) = PReLU ( {α}_{0} 0 + {α}_{1} {a}_{0} + {α}_{2} {b}_{1} + {bias}_{0} ) ,$$

$${u}_{1} = PReLU ( {t}_{1} + {bias}_{1} ) = PReLU ( {β}_{0} {a}_{0} + {β}_{1} {b}_{1} + {β}_{2} {a}_{2} + {bias}_{1} ) ,$$

$${u}_{2} = PReLU ( {t}_{2} + {bias}_{2} ) = PReLU ( {α}_{0} {b}_{1} + {α}_{1} {a}_{2} + {α}_{2} {b}_{3} + {bias}_{2} ) ,$$

$${u}_{3} = PReLU ( {t}_{3} + {bias}_{3} ) = PReLU ( {β}_{0} {a}_{2} + {β}_{1} {b}_{3} + {β}_{2} {a}_{4} + {bias}_{3} ) ,$$

$${u}_{4} = PReLU ( {t}_{4} + {bias}_{4} ) = PReLU ( {α}_{0} {b}_{3} + {α}_{1} {a}_{4} + {α}_{2} {b}_{5} + {bias}_{4} ) ,$$

$${u}_{5} = PReLU ( {t}_{5} + {bias}_{5} ) = PReLU ( {β}_{0} {a}_{4} + {β}_{1} {b}_{5} + {β}_{2} {a}_{6} + {bias}_{5} ) ,$$

$${u}_{6} = PReLU ( {t}_{6} + {bias}_{6} ) = PReLU ( {α}_{0} {b}_{5} + {α}_{1} {a}_{6} + {α}_{2} {b}_{7} + {bias}_{6} ) ,$$

$${u}_{7} = PReLU ( {t}_{7} + {bias}_{7} ) = PReLU ( {β}_{0} {a}_{6} + {β}_{1} {b}_{7} + {β}_{2} 0 + {bias}_{7} ) .$$

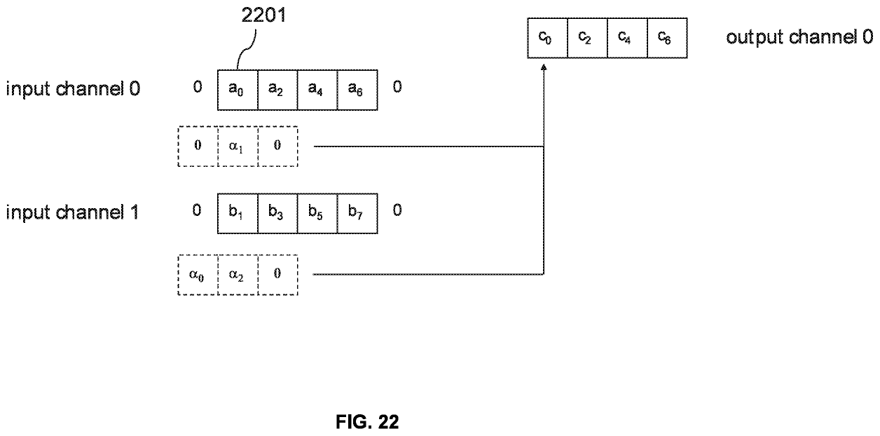

According to embodiments, and with further reference to FIG. 20, pixel unshuffle can be applied to the 1-channel 1×8 input tensor (2001), which generates a two-channel output tensor (2002), where each channel (2003, 2004) is of size 1×4. Next, a non-positional-dependent convolutional layer that inputs 2 channels and outputs 2 channels is used. For output channel 0, a kernel tensor where the matrix for input channel 0 is [0 α₁ 0] and where the matrix for input channel 1 is [α₀ α₂ 0] is used. FIG. 22 shows how the convolution is performed for the first position of output channel 0. When centered on the first sample position (2201), the padded zero and the first two samples [0 a₀ a₂] from input channel 0 will be multiplied using the dot product with the matrix [0 a₁ 0]. Likewise for input channel 1, [0 b₁ b₃] will be multiplied with [a₀ a₂ 0], and the two dot products will be summed together to form the first element in the output channel 0, c0. Thus, the result will be:

$${c}_{0} = ( 0 \times 0 + {α}_{1} \times {a}_{0} + 0 \times {α}_{2} ) + ( {α}_{0} \times 0 + {α}_{2} \times {b}_{1} + 0 \times {b}_{3} ) ,$$

where x denotes regular multiplication of two scalars. This is equal to:

$${c}_{0} = {α}_{1} {a}_{0} + {α}_{2} {b}_{1}$$

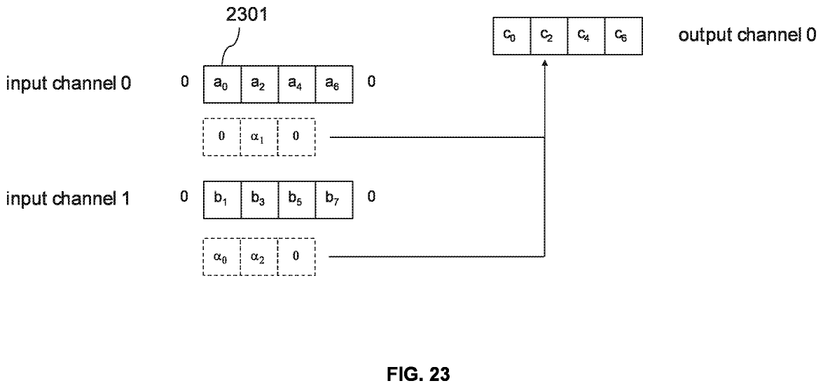

which is equal to t₀. FIG. 23 shows the next position of the output channel 0, with:

$${c}_{2} = ( 0 \times {a}_{0} + {α}_{1} \times {a}_{2} + 0 \times {α}_{4} ) + ( {α}_{0} \times {b}_{1} + {α}_{2} \times {b}_{3} + 0 \times {b}_{5} ) = = {α}_{0} {b}_{1} + {α}_{1} {a}_{2} + {α}_{2} {b}_{3} = {t}_{2} .$$

In the same way, c₄=t₄ and c₆=t₆.

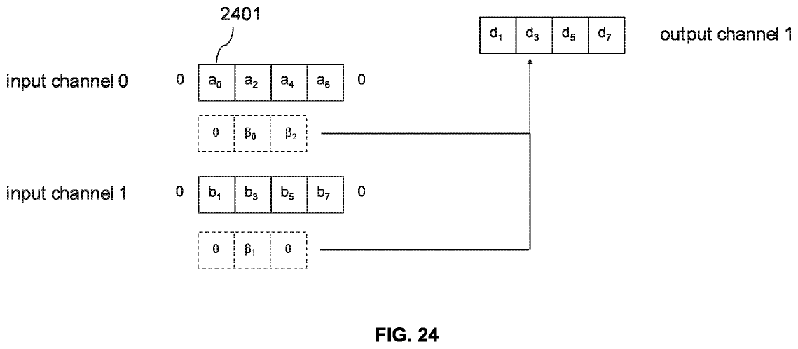

Analogously, FIG. 24 shows what happens for output channel 1. Here, a weight tensor is used where the matrix for input channel 0 is [0 β₀ β₂] and where the matrix for input channel 1 is [0 β₁ 0]. This gives:

$${d}_{3} = 0 \times {a}_{0} + {β}_{0} \times {a}_{2} + {β}_{2} \times {a}_{4} + 0 \times {b}_{1} + {β}_{1} \times {b}_{3} + 0 \times {b}_{5} = = {β}_{0} {a}_{2} + {β}_{1} {b}_{3} + {β}_{2} {a}_{4} = {t}_{3} .$$

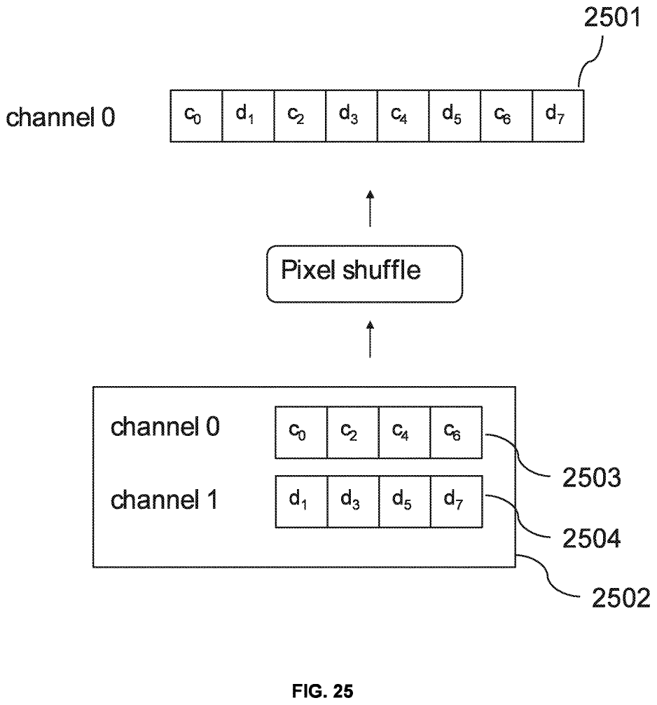

In the same way, d₁=t₁, d₅=tₛ and d₇=t₇ are obtained. After adding bias terms and applying PReLU, pixel shuffle is used to go back from two channels to one, as illustrated in FIG. 25. The result (2501) is:

$$[ \begin{matrix}{c}_{0} & {d}_{1} & {c}_{2} & {d}_{3} & {c}_{4} & {d}_{5} & {c}_{6} & {d}_{7}\end{matrix} ]$$

which (having applied bias and PReLU) is equal to:

$$[ \begin{matrix}{u}_{0} & {u}_{1} & {u}_{2} & {u}_{3} & {u}_{4} & {u}_{5} & {u}_{6} & {u}_{7}\end{matrix} ] .$$

In this respect, and according to some embodiments, a filter is applied by using pixel unshuffle, a regular CNN layer, and pixel shuffle. In this implementation with pixel shuffle, instead of producing every value using a single dot product such as t₂=α₀b₁+α₁a₂+α₂b₃ as when using position-dependent filtering according to other embodiments, two dot products are used, one for each input channel, where c₂=(0×a₀+α₁×a₂+0×α₄)+(a₀×b₁+α₂×b₃+0×b₅). In this example, because half of the weights are zero, they do not contribute to the end result. Hence, in the one-dimensional case, there is double the number of kMACs per sample. In the 2D case, this translates to an increase in kMACs per sample of a factor of 4. As an example, if one used a one-channel input of size 8×8 and a one-channel output of the same size, and a position dependent convolution with a 3×3 kernel, and the repeating block size is 2×2, the position dependent convolution will simply be 3×3=9 MACs per sample. To implement a filter using a pixel shuffle/unshuffled approach as described a above, the 8×8 input is first unshuffled to four channels of 4×4. Then a conv2 with a kernel of 3×3 and 4 channels are needed to get the four output channels. A final pixel shuffle gets back the 8×8 input. This is 3×3×4×8×8=2304 MACs or 2304/(8×8)=36 MACs per sample. The number of parameters may also be four times higher than other embodiments, and 16 times higher than a regular (non-position dependent) CNN.

Aspect of one or more of the embodiments described herein may be combined. For instance, it is possible to combine a network that is using pixel shuffle with one using positional dependent filtering according to embodiments. This is reflected in FIG. 10. A convolution with stride=2 is used to lower the resolution and pixel shuffle is used in the end to get back to the original resolution, but since the trunk is in between, position dependent convolution is used on top of pixels shuffle. However, it may be possible to further improve these results by entirely removing the pixel shuffle and replacing it with only positional dependent filtering.

In some embodiments, not all channels of a convolution are position dependent. As an example, if there are four output channels, the two first may be using position dependent convolutions, whereas the two last may be using ordinary convolutions.

In another embodiment, what filter to select is not predetermined by position, but instead the network selects weight tensors. For example, the network may select one of four potential weight tensors based on a signal. In embodiments, this signal may come from the NN itself or may be an input to the network. As an example, in one embodiment, image gradients are calculated outside the NN and forwarded as an input to the network. If the gradient exceeds a certain value in both the x- and the y-direction, a first weight tensor is used. If the gradient exceeds the threshold only in the x-direction, a second weight tensor is used. If the gradient exceeds the threshold only in the y-direction, a third weight tensor is used, and if the gradient does not exceed the threshold in any direction, a fourth weight tensor is used. While gradient is used in this example, other properties—including other image related properties—may be a basis for selecting a particular weight tensor.

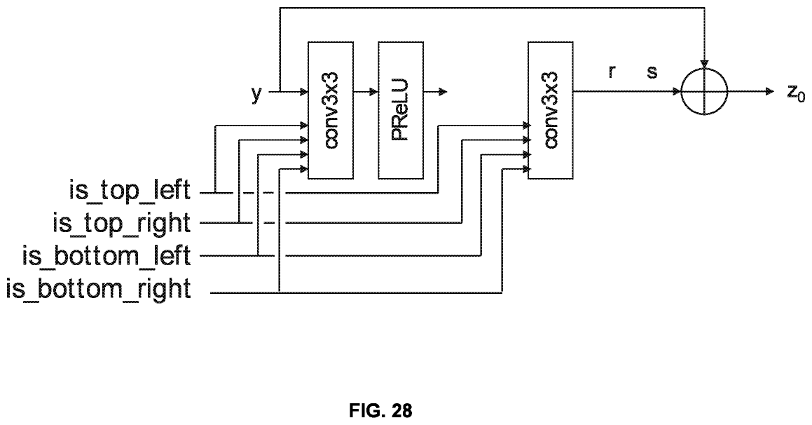

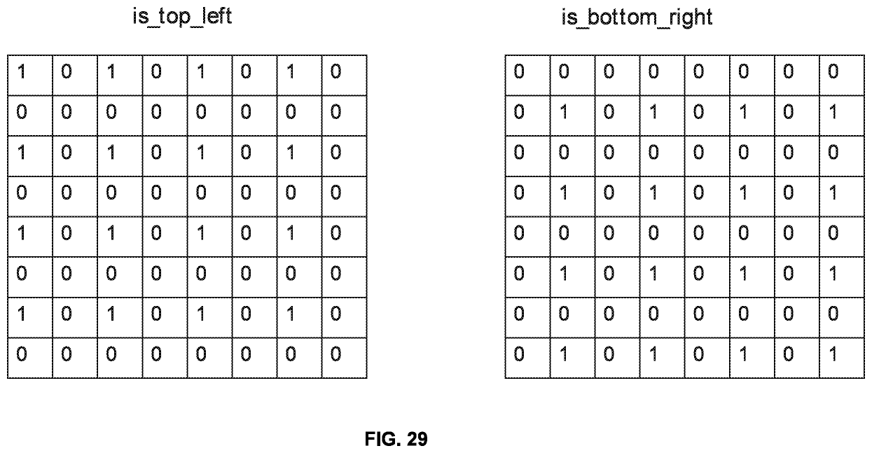

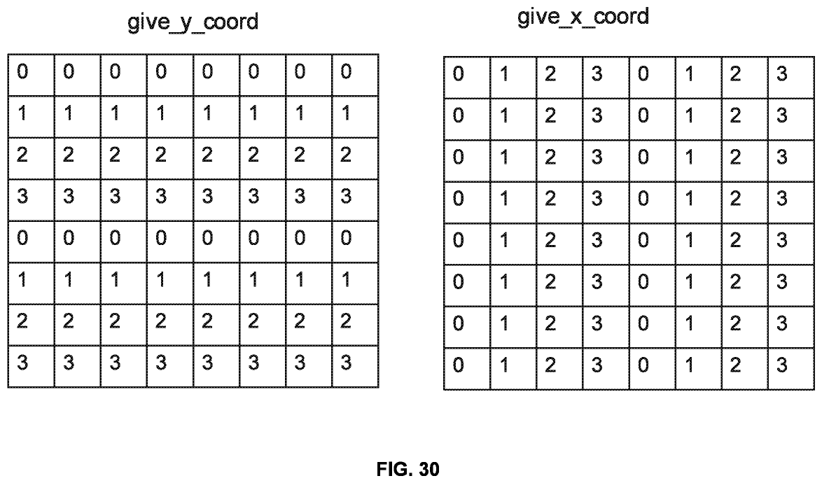

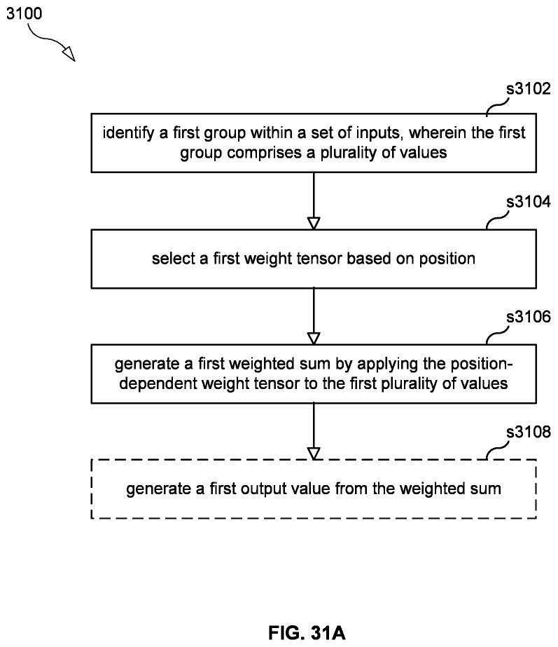

In some embodiments, the neural network is given inputs so that it can differentiate between different relative positions. For instance, the inputs may identity positions within a repeater block. An example is shown in FIG. 28. In this example, four extra inputs are concatenated with the input to each convolutional layer. These inputs are “1” if the sample position is in a specific position inside the repeater block. As an example, the signal “is_top_left” is “1” if the sample coordinate is even in both the x- and y-dimensions, as is shown in FIG. 29. Likewise, the signal “is_bottom_right” is 1 if the sample position is odd in the x- and y-directions, and zero otherwise. This way, it is possible for the convolution to differentiate between sample positions. In an alternative embodiment, (1−is_top_left), (1−is_top_right), (1−is_bottom_right), and (1−is_bottom_right) are instead fed as inputs into the convolutions. As shown, including such inputs means that it is possible for a neural network to learn to a mapping similar to using a specific set of weights if “is_top_left” is 1 and another set of weights if “is_bottom_right” is 1. While four inputs is used as an example, different numbers may be used according to embodiments (e.g., based on repeater block size). FIG. 30 provides another example of how position information can be input to the network, including with x- and y-coordinates. In this case, only two inputs “give_y_coord” and “give_x_coord” are needed rather than the four “is_top left”, “is_top_right”, “is_bottom_left” and “is_bottom_right”.

In some embodiments, if such inputs are fed to the network, it may not be strictly necessary to have different weight matrices in different positions. Instead, the network can learn this behavior even when regular convolutional layers are used. This can be illustrated, for instance, using the one-dimensional dependent filtering example described in connection with FIG. 21, except where ReLUs (rectified linear units) have been used instead of PReLUs (parameterized rectified linear units). In this example, three channels are used as input: channel 0 is the sample input [a₀ bᵢ a₂ b₃ a₄ b₅ a₆ b₇] (2001 in FIG. 21), channel 1 signals even positions [1 0 1 0 1 0 1 0], and channel 2 signals odd positions [0 1 0 1 0 1 0 1]. A convolution can be created from these 3 input channels to two output channels using the following weight tensors. For output channel 0, the following is used:

$$W 0 = [ \begin{matrix}{β}_{0} & {β}_{1} & {β}_{2} \\ 0 & - n & 0 \\ 0 & 0 & 0\end{matrix} ] ,$$

and this means that the output after ReLU will be:

$${s}_{0} = ReLU ( {β}_{0} 0 + {β}_{1} {a}_{0} + {β}_{2} {b}_{1} - n + {bias}_{0} ) ,$$

$${s}_{1} = ReLU ( {β}_{0} {a}_{0} + {β}_{1} {b}_{1} + {β}_{2} {a}_{2} + {bias}_{1} ) ,$$

$${s}_{2} = ReLU ( {β}_{0} {b}_{1} + {β}_{1} {a}_{2} + {β}_{2} {b}_{3} - n + {bias}_{2} ) ,$$

$${s}_{3} = ReLU ( {β}_{0} {a}_{2} + {β}_{1} {b}_{3} + {β}_{2} {a}_{4} + {bias}_{3} ) ,$$

$${s}_{4} = ReLU ( {β}_{0} {b}_{3} + {β}_{1} {a}_{4} + {β}_{2} {b}_{5} - n + {bias}_{4} ) ,$$

$${s}_{5} = ReLU ( {β}_{0} {a}_{4} + {β}_{1} {b}_{5} + {β}_{2} {a}_{6} + {bias}_{5} )$$

$${s}_{6} = ReLU ( {β}_{0} {b}_{5} + {β}_{1} {a}_{6} + {β}_{2} {b}_{7} - n + {bias}_{6} ) ,$$

$${s}_{7} = ReLU ( {β}_{0} {a}_{6} + {β}_{1} {b}_{7} + {β}_{2} 0 + {bias}_{7} ) .$$

If n is set large enough, the expressions inside the ReLU functions that contain n will become negative and the ReLU outputs will be zero. Thus, s₀=s₂=s₄=s₆=0. However, s₁ will be the same as the value u₁ discussed above in connection with FIG. 21. Likewise, s₃=u₃, s₅=u₅ and s₇=u₇. For output channel 1, the following weight tensor can be used instead:

$$W 1 = [ \begin{matrix}{α}_{0} & {α}_{1} & {α}_{2} \\ 0 & 0 & 0 \\ 0 & - n & 0\end{matrix} ] .$$

This means that the output will, if n is large enough, be equal to:

$${v}_{0} = ReLU ( {α}_{0} 0 + {α}_{1} {a}_{0} + {α}_{2} {b}_{1} + {bias}_{0} ) = {u}_{0} ,$$

$${v}_{1} = ReLU ( {α}_{0} {a}_{0} + {α}_{1} {b}_{1} + {α}_{2} {a}_{2} - n + {bias}_{1} ) = 0 ,$$

$${v}_{2} = ReLU ( {α}_{0} {b}_{1} + {α}_{1} {a}_{2} + {α}_{2} {b}_{3} + {bias}_{2} ) = {u}_{2} ,$$

$${v}_{3} = ReLU ( {α}_{0} {a}_{2} + {α}_{1} {b}_{3} + {α}_{2} {a}_{4} - n + {bias}_{3} ) = 0 ,$$

$${v}_{4} = ReLU ( {α}_{0} {b}_{3} + {α}_{1} {a}_{4} + {α}_{2} {b}_{5} + {bias}_{4} ) = {u}_{4} ,$$

$${v}_{5} = ReLU ( {α}_{0} {a}_{4} + {α}_{1} {b}_{5} + {α}_{2} {a}_{6} - n + {bias}_{5} ) = 0 ,$$

$${v}_{6} = ReLU ( {α}_{0} {b}_{5} + {α}_{1} {a}_{6} + {α}_{2} {b}_{7} + {bias}_{6} ) = {u}_{6} ,$$

$${v}_{7} = ReLU ( {α}_{0} {a}_{6} + {α}_{1} {b}_{7} + {α}_{2} 0 - n + {bias}_{7} ) = 0 .$$

A subsequent layer can add these two channels together with equal weights and get similar values as the output u discussed in connection with FIG. 21:

$${s}_{0} + {v}_{0} = 0 + {u}_{0} = {u}_{0} ,$$

$${s}_{1} + {v}_{1} = {u}_{1} + 0 = {u}_{1} ,$$

$$⋯$$

$${s}_{7} + {v}_{y} = {u}_{7} + 0 = {u}_{7} .$$

Hence, at least in the case when ReLUs are used rather than PReLUs, it is possible to provide a filter with regular convolutions according to some embodiments.

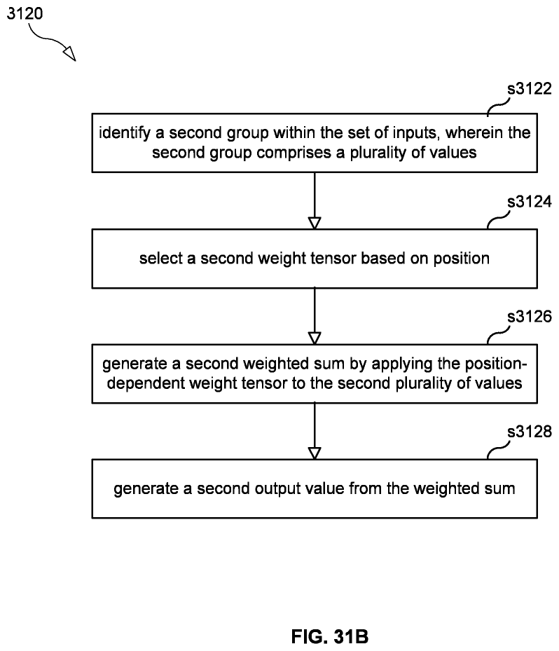

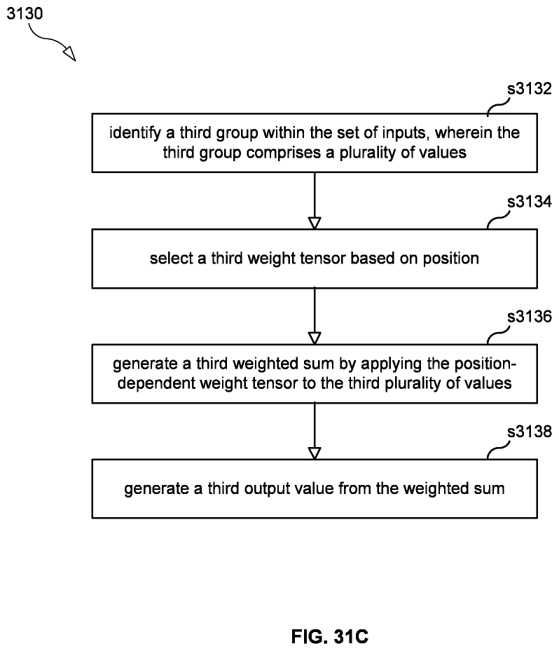

Referring now to FIG. 31A, a process 3100 is provided according to some embodiments. The process may be performed, for instance, in an apparatus 3300, including in a decoder or encoder. In some embodiments, process 3100 is applied in a convolutional layer of a neural network filter (e.g., within a head, trunk/body, or tail of a NN feature). This could include, for example, as part of the processing described in connection with FIG. 2, FIG. 3, and FIGS. 4A-4C. The process 3100 may begin with step s3102, in which a first group within a set of inputs is identified, where the first group comprises a plurality of values. The set of inputs may be divided into repeater blocks. In some embodiments, the set of inputs is a block, frame, or group of samples or other values. The inputs may correspond to (e.g., be derived from) one or more samples of a video picture. However, process 3100 is not limited to video processing in some embodiments. In step s3104, a first weight tensor is selected based on the position of a first value of the group. For instance, a weight tensor may be selected based on the position of a value in a repeater block (e.g., whether it is near an edge, corner, center, etc.), or based on an absolute position of the value (e.g., a row-column position in the set of inputs). In some embodiments, the weight tensor may be selected, at least in part, on a received position signal. In step s3106, a first weighted sum is generated by applying the position-dependent weight tensor to the first plurality of values. In step s3108, which may be optional in some embodiments, an output value is generated from the weighted sum. This could include, for example, processing the first weighted sum with a non-linear activation function, such as a parametric rectified linear unit.

Referring now to FIGS. 31B and 31C, additional processing may be performed with respect to the set of inputs according to processes 3120 and 3130. For example, additional groups may be identified, additional weight tensors selected, and additional weighted sums generated. These weighted sums can be used to generate additional outputs.

Process 3120 comprises: identifying (s3122) a second group within the set of inputs, wherein the second group comprises a plurality of values; selecting (s3124) a second weight tensor based on position; generating (s3126) a second weighted sum by applying the position-dependent weight tensor to the second plurality of values; and, optionally, generating (s3128) a second output value from the weighted sum. According to embodiments, the first weight tensor is different than the second weight tensor. Process 3120 may be performed, for example, with one or more steps of process 3100.

Process 3130 comprises: identifying (s3132) a third group within the set of inputs, wherein the third group comprises a plurality of values; selecting (s3134) a third weight tensor based on position; generating (s3136) a third weighted sum by applying the position-dependent weight tensor to the third plurality of values; and generating (s3138) a third output value from the weighted sum. Process 3130 may be performed, for example, with one or more steps of process 3100, and process 3130 may also be performed with one or more steps of process 3120. According to some embodiments, the first and third weight tensors are the same when a position of the first value and a position of the third value are the same (e.g., they are in the same relative location of a repeater block even though they are at different absolute locations in the set of inputs). Additionally, the first and third groups may be partially overlapping or non-overlapping in embodiments.

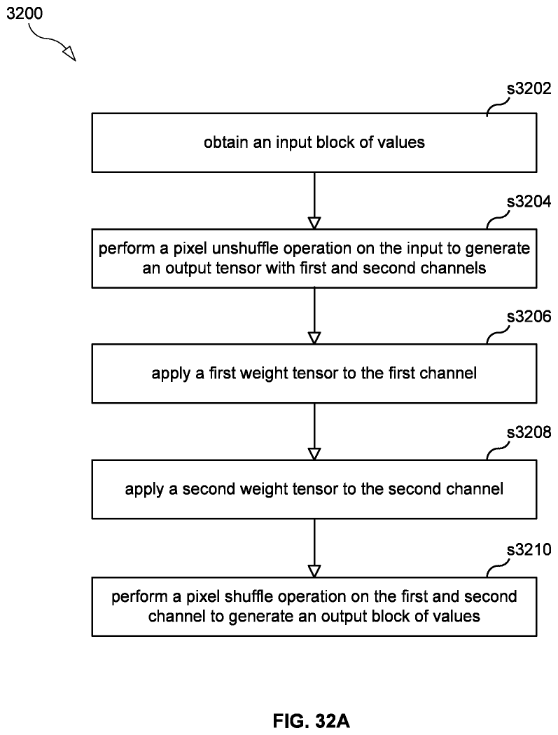

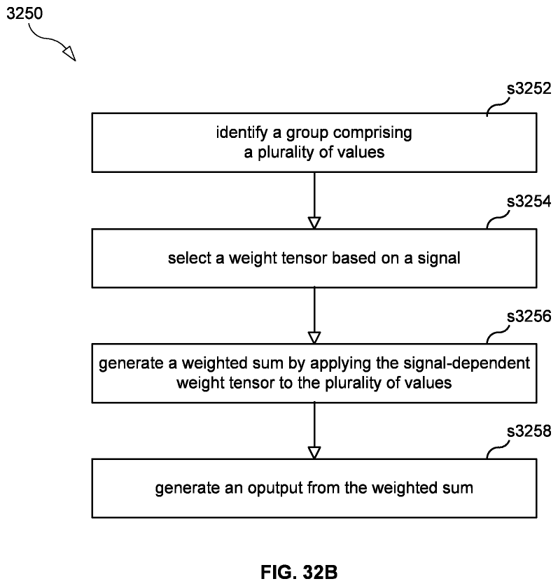

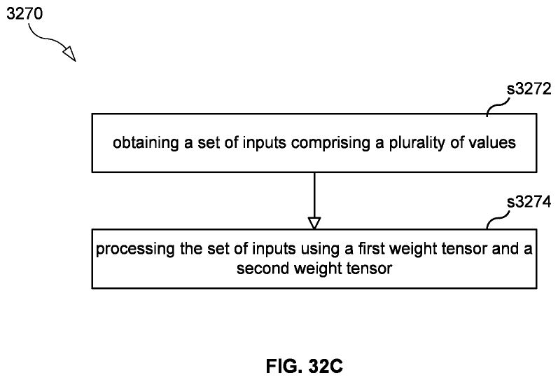

Referring now to FIG. 32A, a process 3200 is provided according to some embodiments. The process may be performed, for instance, in an apparatus 3300, including in a decoder or encoder. In some embodiments, process 3200 is applied in a convolutional layer of a neural network filter (e.g., within a head, trunk/body, or tail of a NN feature). This could include, for example, as part of the processing described in connection with other figures. The process 3200 may begin with step s3202, in which an input block of values is obtained. In some embodiments, the input is a block, frame, or group of samples or other values. The values may correspond to (e.g., be derived from) one or more samples of a video picture. However, process 3200 is not limited to video processing in some embodiments. In step s3204, a pixel unshuffled operation is performed on the input to generate an output tensor with first and second channels. In step s3206 a first weight tensor is applied to the first channel and in step s3208 a second weight tensor is applied to the second channel. In step s3210, an unshuffle operation is performed on the first and second channels to generate an output (e.g., an output block of values).

Referring now to FIG. 32B, a process 3250 is provided according to some embodiments. The process may be performed, for instance, in an apparatus 3300, including in a decoder or encoder. In some embodiments, process 3250 is applied in a convolutional layer of a neural network filter (e.g., within a head, trunk/body, or tail of a NN feature). This could include, for example, as part of the processing described in connection with other figures. The process 3200 may begin with step s3252, in which a group is identified that comprises a plurality of values. In some embodiments, the group is a block, frame, or group of samples or other values. The values may correspond to (e.g., be derived from) one or more samples of a video picture. However, process 3250 is not limited to video processing in some embodiments. In step s3254, a weight tensor is selected based on a signal. In step s3256, a weight sum is generated by applying the signal-dependent weight tensor to the plurality of values. In step s3258, an output is generated from the weighted sum.

Referring now to FIG. 32C, a process 3270 is provided according to some embodiments. The process may be performed, for instance, in an apparatus 3300, including in a decoder or encoder. In some embodiments, process 3250 is applied in a convolutional layer of a neural network filter (e.g., within a head, trunk/body, or tail of a NN feature). This could include, for example, as part of the processing described in connection with other figures. The process 3200 may comprise: obtaining (s3272) a set of inputs comprising a plurality of values; and processing (s3274) the set of inputs using a first weight tensor and a second weight tensor. According to embodiments, values corresponding to a first position are processed with the first weight tensor, values corresponding to a second position are processed with the first weight tensor, and values corresponding to a third position are with the second weight tensor. In certain aspects, the process 3270 may have two features. In a first aspect, at least one position within a repeater block (or other similar grouping) uses a different weight matrix than another position. In a second aspect, the repeater block is repeated at least once.

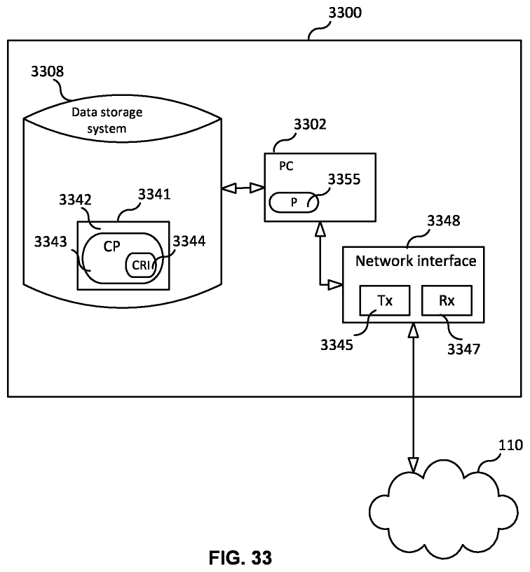

FIG. 33 is a block diagram of an apparatus 3300 for implementing the encoder 112, the decoder 114, or a component included in the encoder 112 or the decoder 114 (e.g., the NN filter 280 or 330), according to some embodiments. When apparatus 3300 implements a decoder, apparatus 3300 may be referred to as a “decoding apparatus 3300,” and when apparatus 3300 implements an encoder, apparatus 3300 may be referred to as an “encoding apparatus 3300.” As shown in FIG. 33, apparatus 3300 may comprise: processing circuitry (PC) 3302, which may include one or more processors (P) 3355 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 3300 may be a distributed computing apparatus); at least one network interface 3348 comprising a transmitter (Tx) 3345 and a receiver (Rx) 3347 for enabling apparatus 3300 to transmit data to and receive data from other nodes connected to a network 110 (e.g., an Internet Protocol (IP) network) to which network interface 3348 is connected (directly or indirectly) (e.g., network interface 3348 may be wirelessly connected to the network 110, in which case network interface 3348 is connected to an antenna arrangement); and a storage unit (a.k.a., “data storage system”) 3308, which may include one or more non-volatile storage devices and/or one or more volatile storage devices. In embodiments where PC 3302 includes a programmable processor, a computer program product (CPP) 3341 may be provided. CPP 3341 includes a computer readable medium (CRM) 3342 storing a computer program (CP) 3343 comprising computer readable instructions (CRI) 3344. CRM 3342 may be a non-transitory computer readable medium, such as, magnetic media (e.g., a hard disk), optical media, memory devices (e.g., random access memory, flash memory), and the like. In some embodiments, the CRI 3344 of computer program 3343 is configured such that when executed by PC 3302, the CRI causes apparatus 3300 to perform steps described herein (e.g., steps described herein with reference to the flow charts). In other embodiments, apparatus 3300 may be configured to perform steps described herein without the need for code. That is, for example, PC 3302 may consist merely of one or more ASICs. Hence, the features of the embodiments described herein may be implemented in hardware and/or software.

### Summary of Embodiments

A1. A method, comprising:
   identifying a first group within a set of inputs, wherein the first group comprises a first plurality of values;
   selecting a first weight tensor, wherein the first weight tensor is selected based at least in part on a position of a first value; and
   generating a first weighted sum by applying the first weight tensor to the first plurality of values.
A2. The method of A1, further comprising:
   identifying a second group within the set of inputs, wherein the second group comprises a second plurality of values;
   selecting a second weight tensor, wherein the second weight tensor is selected based at least in part on a position of a second value; and
   generating a second weighted sum by applying the second weight tensor to the second plurality of values.
A3. The method of A2, wherein the first and second weight tensors are different.
A4. The method of A2 or A3, wherein the first and second groups partially overlap in the set of inputs.
A5. The method of any of A1-A4, further comprising:
   identifying a third group within a set of inputs, wherein the third group comprises a third plurality of values;
   selecting a third weight tensor, wherein the third weight tensor is selected based at least in part on a position of a third value; and
   generating a third weighted sum by applying the third weight tensor to the third plurality of values.
A6. The method of A5,
wherein the first and third weight tensors are the same, and
wherein a position of the first value and a position of the third value are the same (e.g., are in the same location of a repeater block).
A7. The method of A5 or A6,
wherein the first and third weight tensors are the same, and
wherein a position of the first value in the set of inputs and a position of the third value in the set of inputs are different.
A8. The method of any of A5-A7, wherein the first and third groups do not overlap in the set of inputs.
A9. The method of any of A5-A7, wherein the first and third groups partially overlap in the set of inputs.
A10. The method of claim any of A1-A9, further comprising performing one or more of:
   generating a first output value (e.g., by processing the first weighted sum with a non-linear activation function, such as a parametric rectified linear unit); and/or
   generating a second output value (e.g., by processing the second weighted sum with a non-linear activation function, such as a parametric rectified linear unit); and/or
   generating a third output value (e.g., by processing the third weighted sum with a non-linear activation function, such as a parametric rectified linear unit).
A11. The method of any of A1-A10, wherein the set of inputs is divided into n×n (e.g., with n=2, 3, 4, or 8) or n×m (e.g., with n≠m) repeater blocks.
A12. The method of A11, wherein the first weight tensor is selected based on the first value having one of the following positions in a repeater block of the set of inputs:
   (i) a central position in a repeater block;
   (ii) a lower left position in a repeater block;
   (iii) a lower right position in a repeater block;
   (iv) an upper middle position a repeater block;
   (v) a lower middle position a repeater block;
   (vi) a middle-left position in a repeater block;
   (vii) a middle-right position in a repeater block;
   (viii) a left-most position in a repeater block;
   (ix) a right-most position in a repeater block;
   (x) an uppermost position in a repeater block;
   (xi) a lowest position in a repeater block;
   (xii) an internal position in a repeater block;
   (xiii) an upper left position in a repeater block; or
   (xiv) an upper right position in a repeater block.
A13. The method of any of claims A1-A12, wherein the first weight tensor is selected based on a distance of the first value to a repeater block boundary (e.g., whether the first value is located at an edge of a repeater block, at a corner of a repeater block, or away from the edges of a repeater block).
A14. The method of any of A1-A13, wherein the first value is a centrally located value within the first group.
A15. The method of any of A1-A14, wherein the second value is a centrally located value within the second group, and the third value is a centrally located value within the third group.
A16. The method of any of A1-A15, wherein the method is applied in a convolutional layer of a neural network filter.
A17. The method of any of A1-A16, wherein the method is applied in the head, trunk/body, and/or tail of a neural network feature.
A18. The method of any of A1-A17, wherein the method is applied in only a subset of convolutional layer layers of a given neural network filter or neural network part (e.g., a head, trunk/body, or tail), or applied only to a subset of channels.
A19. The method of any of A1-A18, wherein the set of inputs are values corresponding to (e.g., derived from) a video picture.
A20. The method of any of A1-A18, wherein the set of inputs are values corresponding to (e.g., derived from) a one-dimensional source signal (e.g., a sound signal or text signal).
A21. The method of any of A1-A20, wherein the method is performed as a filtering step (or as part of a filtering step) in an encoding or decoding process.
A22. The method of any of A1-A21, wherein one or more weight values within a weight tensor are defined based on the position of the value to which the weight tensor is applied.
A23. The method of any of A1-A21, wherein positions within the set of inputs are defined in a checkerboard arrangement.
A24. The method of any of A1-A23, further comprising:
   performing a shuffle and/or unshuffled operation on one or more values (e.g., the values of the groups or the output values).
A25. The method of any of A1-24, wherein selecting a weight tensor is based at least in part on an input signal indicating the position of a value.
A26. The method of A25, wherein the input signal is concatenated with the input to a convolutional layer performing the method.
A27. The method of any of A1-A26, wherein the first weight tensor is selected at least in part based on the position of the first value within the set of inputs.
B1. A method, comprising,
   obtaining an input block of values;
   performing a pixel unshuffle operation on the input block of values to generate an output tensor, wherein the output tensor comprises at least a first and second channel;
   applying a first weight tensor to the first channel;
   applying a second weight tensor to the second channel; and
   performing a pixel shuffle operation on the first and second channel to obtain an output block of values, wherein the first and second weight tensors are different.
B2. The method of A1, wherein each of the first and second weight tensors comprise one or more zero padding values.
C1. A method, comprising:
   identifying a group within a set of inputs, wherein the group comprises a plurality of values;
   selecting a weight tensor, wherein the weight tensor is selected based at least in part on a signal; and
   generating a weighted sum by applying the weight tensor to the plurality of values.
C2. The method of C1, further comprising:
   receiving the signal (e.g., as an input to the network).
C3. The method of C1 or C2, wherein the signal comprises at least one value.
C4. The method of C3, wherein selecting the weight tensor comprises:
   comparing the value to a threshold.
C5. The method of C3 or C4, wherein:
   the value exceeds a threshold in both the x- and the y-direction and a first weight tensor is selected;
   the value exceeds a threshold only in the x-direction and a second weight tensor is selected;
   the value exceeds at threshold only in the y-direction and a third weight tensor is selected; and/or
   the value does not exceed a threshold in any direction and a fourth weight tensor is selected.
C6. The method of any of C1-C5, further comprising:
   generating an output (e.g., by processing the weighted sum with a non-linear activation function, such as a parametric rectified linear unit).
C7. The method of any of C1-C6, where in the signal is indicative of an image property (e.g., gradient).
D1. A method comprising:
   obtaining a set of inputs comprising a plurality of values; and
   processing the set of inputs using a first weight tensor and a second weight tensor, wherein:
   (i) values corresponding to a first position are processed with the first weight tensor,
   (ii) values corresponding to a second position are processed with the first weight tensor, and
   (iii) values corresponding to a third position are processed with the second weight tensor.
D2. The method of D1, wherein the positions are positions within a repeater block of the set of inputs.
D3. The method of D2, wherein the first and third positions are positions within the same repeater block.
D4. The method of D2, wherein the first and third positions are positions within different repeater blocks.
D5. The method of any of D2-D4, wherein the first and second positions are equivalent positions within two different (i.e., repeated) repeater blocks of the set of inputs.
D6. The method of any of D2-D4, wherein the first and second positions are within the same repeater block.
D7. The method of D1, wherein the positions are locations within the set of inputs.
E1. An apparatus configured to perform the method of any one of embodiments A1-A27, B1-B2, C1-C7, and D1-D7.
E2. The apparatus of E1, wherein the apparatus is an encoder or decoder.
E3. The apparatus of E1 or E2, comprising:
   a memory; and
   processing circuitry coupled to the memory, wherein the apparatus is configured to perform the method of any one of embodiments A1-A27, B1-B2, C1-C7, and D1-D7.
F1. A computer program comprising instructions that when executed by processing circuitry cause the processing circuitry to perform the method of any one of A1-A27, B1-B2, C1-C7, and D1-D7.
F2. A carrier containing the computer program of F1, wherein the carrier is one of an electronic signal, an optical signal, a radio signal, and a computer readable storage medium.
G1. An apparatus configured to:
   identify a first group within a set of inputs, wherein the first group comprises a first plurality of values;
   select a first weight tensor, wherein the first weight tensor is selected based at least in part on a position of a first value; and
   generate a first weighted sum by applying the first weight tensor to the first plurality of values.
G2. The apparatus of embodiment G1, wherein the apparatus is further configured to perform the method of any one of embodiments A2-A27.
G3. The apparatus of G1 or G2, wherein the apparatus is configured to generate encoded or decoded video.
H1. An apparatus configured to:
   obtain an input block of values;
   perform a pixel unshuffle operation on the input block of values to generate an output tensor, wherein the output tensor comprises at least a first and second channel;
   apply a first weight tensor to the first channel;
   apply a second weight tensor to the second channel; and
   perform a pixel shuffle operation on the first and second channel to obtain an output block of values,
   wherein the first and second weight tensors are different.
H2. The apparatus of embodiment H1, wherein the apparatus is further configured to perform the method of embodiment B2.
H3. The apparatus of H1 or H2, wherein the apparatus is configured to generate encoded or decoded video.
I1. An apparatus configured to:
   identify a group within a set of inputs, wherein the group comprises a plurality of values;
   select a weight tensor, wherein the weight tensor is selected based at least in part on a signal; and
   generate a weighted sum by applying the weight tensor to the plurality of values.
I2. The apparatus of embodiment I1, wherein the apparatus is further configured to perform the method of any one of embodiments C2-C7.
I3. The apparatus of I1 or I2, wherein the apparatus is configured to generate encoded or decoded video.
J1. An apparatus configured to:
   obtain a set of inputs comprising a plurality of values; and
   process the set of inputs using a first weight tensor and a second weight tensor, wherein:
   (i) values corresponding to a first position are processed with the first weight tensor,
   (ii) values corresponding to a second position are processed with the first weight tensor, and
   (iii) values corresponding to a third position are processed with the second weight tensor.
J2. The apparatus of embodiment J1, wherein the apparatus is further configured to perform the method of any one of embodiments D2-D7.
J3. The apparatus of J1 or J2, wherein the apparatus is configured to generate encoded or decoded video.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-24. (canceled)

25. A method, comprising:
identifying a first group within a set of inputs, wherein the first group comprises a first plurality of values and wherein the set of inputs is divided into n×n or n×m repeater blocks;
selecting a first weight tensor, wherein the first weight tensor is selected based on a first value having one of the following positions in a repeater block of the set of inputs: top left position, top right position, bottom left position and bottom right position;
generating a first weighted sum by applying the first weight tensor to the first plurality of values;
identifying a second group within the set of inputs, wherein the second group comprises a second plurality of values;
selecting a second weight tensor, wherein the second weight tensor is selected based at least in part on a position of a second value, wherein the second weight tensor is different than the first weight tensor;
generating a second weighted sum by applying the second weight tensor to the second plurality of values;
identifying a third group within a set of inputs, wherein the third group comprises a third plurality of values;
selecting a third weight tensor, wherein the third weight tensor is selected based at least in part on a position of a third value; and
generating a third weighted sum by applying the third weight tensor to the third plurality of values;
wherein the first and third weight tensors are the same,
further comprising performing one or more of:
generating a first output value by processing the first weighted sum with a non-linear activation function;
generating a second output value by processing the second weighted sum with a non-linear activation function;
generating a third output value by processing the third weighted sum with a non-linear activation function.

26. The method of claim 25, wherein the position of the first value in the repeater block and the position of the third value in the repeater block are the same.

27. The method of claim 25, wherein the position of the first value in the repeater block and the position of the second value in the repeater block are different.

28. The method of claim 25, wherein the first weight tensor is selected based on a distance of the first value to a repeater block boundary.

29. The method of claim 25, wherein the first value is a centrally located value within the first group.

30. The method of claim 25, wherein the second value is a centrally located value within the second group, and the third value is a centrally located value within the third group.

31. The method of claim 25, wherein the method is applied in a convolutional layer of a neural network filter.

32. The method of claim 25, wherein the method is applied in the head, trunk/body, or tail of a neural network feature.

33. The method of claim 25, wherein the method is applied in only a subset of convolutional layer layers of a given neural network filter or neural network part or applied only to a subset of channels.

34. The method of claim 25, wherein the set of inputs are values corresponding to a video picture.

35. The method of claim 25, wherein the method is performed as a filtering step or as part of a filtering step in an encoding or decoding process.

36. The method of claim 25, wherein positions within the set of inputs are defined in a checkerboard arrangement.

37. The method of claim 25, further comprising:
performing a shuffle or unshuffled operation on one or more values.

38. An apparatus configured to perform the method of claim 25, wherein the apparatus is an encoder or decoder.

39. A non-transitory computer readable medium storing a computer program comprising instructions which when executed by processing circuitry causes the processing circuitry to perform the method of claim 25.

40. An apparatus, the apparatus comprising:
memory; and
processing circuitry coupled to the memory, wherein the apparatus is configured to perform a method comprising:
identifying a first group within a set of inputs, wherein the first group comprises a first plurality of values and wherein the set of inputs is divided into n×n or n×m repeater blocks;
selecting a first weight tensor, wherein the first weight tensor is selected based on a first value having one of the following positions in a repeater block of the set of inputs: top left position, top right position, bottom left position and bottom right position;
generating a first weighted sum by applying the first weight tensor to the first plurality of values;
identifying a second group within the set of inputs, wherein the second group comprises a second plurality of values;
selecting a second weight tensor, wherein the second weight tensor is selected based at least in part on a position of a second value, wherein the second weight tensor is different than the first weight tensor;
generating a second weighted sum by applying the second weight tensor to the second plurality of values;
identifying a third group within a set of inputs, wherein the third group comprises a third plurality of values;
selecting a third weight tensor, wherein the third weight tensor is selected based at least in part on a position of a third value; and
generating a third weighted sum by applying the third weight tensor to the third plurality of values;
wherein the first and third weight tensors are the same, further comprising performing one or more of:
generating a first output value by processing the first weighted sum with a non-linear activation function;
generating a second output value by processing the second weighted sum with a non-linear activation function;
generating a third output value by processing the third weighted sum with a non-linear activation function.

41. The apparatus of claim 40, wherein the apparatus is an encoder or decoder.
